(19) United States
(12) Patent Application Publication
(10) Pub. No.: US 2018/0107971 A1
(43) Pub. Date: Apr. 19, 2018

(54) AGGREGATE MOBILE ANALYTICS-BASED INVENTORY ACTIVITY IDENTIFICATION SYSTEMS AND METHODS

(71) Applicant: Wal-Mart Stores, Inc., Bentonville, AR (US)

(72) Inventors: Greg N. Vukin, Bentonville, AR (US); Todd D. Mattingly, Bentonville, AR (US); Bruce W. Wilkinson, Rogers, AR (US)

(21) Appl. No.: 15/782,509

(22) Filed: Oct. 12, 2017

Related U.S. Application Data
(60) Provisional application No. 62/410,155, filed on Oct. 19, 2016.
(60) Provisional application No. 62/486,801, filed on Apr. 18, 2017.
(60) Provisional application No. 62/436,842, filed on Dec. 20, 2016.
(60) Provisional application No. 62/485,045, filed on Apr. 13, 2017.

(51) Int. Cl. G06Q 10/08

(52) U.S. Cl. CPC G06Q 10/087

(57) ABSTRACT

Some embodiments provide retail product inventory distribution systems, comprising: an inventory tracking system; an inventory management control circuit configured to couple with a source of multiple different types of mobile analytics information, and to: electronically access aggregated layers of multiple different types of mobile analytics information corresponding to activities associated with multiple different electronic user devices; identify, based on at least a first pattern of activity determined from the aggregated multiple different types of mobile analytics information, an inventory adjustment activity to be implemented as a function of the first pattern of activity relative to retail services; and communicate instructions to cause the inventory adjustment activity to be implemented.

### RELATED APPLICATIONS

This application claims the benefit of U.S. Provisional Application No. 62/410,155, filed Oct. 19, 2016, U.S. Provisional Application No. 62/486,801, filed Apr. 18, 2017, U.S. Provisional Application No. 62/436,842, filed Dec. 20, 2016, and U.S. Provisional Application No. 62/485,045, filed Apr. 13, 2017, all of which are incorporated herein by reference in their entirety.

### TECHNICAL FIELD

These teachings relate generally to systems to distribute inventory based on mobile analytics.

### BACKGROUND

Various branches of mobile analytics are known in the art. As used herein, “mobile analytics” refers to data representing the location and travel over time of mobile communications devices such as cellular telephony devices (including both voice only, data only, and both voice and data compatible devices) and the analysis of such data. Mobile analytics data can be real-time, near-real time (where the data represents circumstances within at least the past, say, ten seconds, thirty seconds, one minute, or the like), and/or historical scenarios.

Mobile analytics data can be captured, for example, by cellular telephony service providers by recording and aggregating as appropriate the service provider's view of their mobile subscribers as those subscribers move and become attached to or otherwise viewed by various cell towers. In many cases a given customer device is visible to a plurality of antenna towers and the location of the customer device can be reliably ascertained by triangulating that location based, for example, on the relative strength of the device's signal at each of the towers. It is also possible that a customer device may have its own native capability of ascertaining its own location, which location the device transmits to the service provider on a push or pull basis as desired to support any of a variety of services (such as, for example, presence-based services).

Mobile analytics data has been analyzed to identify, for example, cellular towers or other network elements that are relatively overloaded and which need to be upgraded or supplemented to continue to assure a quality customer experience. More recently there have been suggestions that mobile analytics data might be useful to retailers and other non-communications service providers to help with their marketing plans. To date, however, such possibilities remain largely without realization.

### BRIEF DESCRIPTION OF THE DRAWINGS

The above needs are at least partially met through provision of the mobile analytics-based inventory distribution systems and method described in the following detailed description, particularly when studied in conjunction with the drawings, wherein:

FIG. 1 comprises a flow diagram as configured in accordance with various embodiments of these teachings;

FIG. 2 comprises a mobile analytics map as configured in accordance with various embodiments of these teachings;

FIG. 3 comprises a flow diagram as configured in accordance with various embodiments of these teachings;

FIG. 4 comprises a block diagram as configured in accordance with various embodiments of these teachings;

FIG. 5 comprises a flow diagram as configured in accordance with various embodiments of these teachings;

FIG. 6 comprises a flow diagram as configured in accordance with various embodiments of these teachings;

FIG. 7 comprises a graphic representation as configured in accordance with various embodiments of these teachings;

FIG. 8 comprises a graph as configured in accordance with various embodiments of these teachings;

FIG. 9 comprises a flow diagram as configured in accordance with various embodiments of these teachings;

FIG. 10 comprises a graphic representation as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a flow diagram as configured in accordance with various embodiments of these teachings;

FIG. 14 comprises a flow diagram as configured in accordance with various embodiments of these teachings;

FIG. 15 comprises a graphic representation as configured in accordance with various embodiments of these teachings;

FIG. 16 comprises a graphic representation as configured in accordance with various embodiments of these teachings;

FIG. 17 comprises a block diagram as configured in accordance with various embodiments of these teachings;

FIG. 18 comprises a flow diagram as configured in accordance with various embodiments of these teachings;

FIG. 19 comprises a graph as configured in accordance with various embodiments of these teachings;

FIG. 20 comprises a flow diagram as configured in accordance with various embodiments of these teachings;

FIG. 21 comprises a block diagram as configured in accordance with various embodiments of these teachings;

FIG. 22 comprises a simplified block diagram in accordance with some embodiments;

FIG. 23 illustrates a simplified flow diagram in accordance with some embodiments;

FIG. 24 illustrates a simplified block diagram of a system to assess purchase opportunities corresponding to the sale of commercial objects, in accordance with some embodiments;

FIG. 25 is a flowchart of an exemplary process of assessing purchase opportunities corresponding to the sale of commercial objects, in accordance with several embodiments; and

FIG. 26 illustrates an exemplary system for use in implementing methods, techniques, devices, apparatuses, systems, servers, sources and providing inventory distribution and access to purchase opportunities, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to these various embodiments and by one approach, an enabling apparatus includes a retail shopping facility, a customer-device interface configured and disposed to interact with a customer's device proximal to the retail shopping facility to thereby receive from the customer's device a first unique identifier, and a control circuit that operably couples to the customer-device interface. By one approach, and subject to customer permission, the control circuit serves to access mobile analytics information regarding locations of customer devices and identifying information for the customer devices comprising a second unique identifier that is different from the first unique identifier. By then also accessing identifying information for customers of the retail shopping facility the control circuit uses the first identifier, the second unique identifier, and the identifying information for customers of the retail shopping facility to correlate the second unique identifier with a particular corresponding customer.

So configured, anonymous mobile analytics information can be personalized for at least some of the persons associated with the represented mobile devices. The mobile analytics information, so personalized, can then be leveraged in various ways. By one approach, for example, that information can serve to help identify specific customer-based actions to facilitate.

These teachings are highly flexible in practice. By one approach, for example, the aforementioned customer-device interface comprises a wireless interface such as but not limited to a Wi-Fi access point or a Bluetooth transceiver.

As another example, these teachings will accommodate a variety of different identifiers to serve as the aforementioned first and second unique identifiers. By one approach, for example, the aforementioned first unique identifier can comprise a Media Access Control (MAC) identifier for the corresponding customer's device. The aforementioned second unique identifier, in turn, can comprise, for example, a mobile device Electronic Serial Number (ESN), a mobile device International Mobile Equipment Identity (IMEI) number, or a number (other than a telephone number) assigned by a wireless-communications service provider, to note but a few salient examples in these regards.

The aforementioned identifying information for customers of the retail shopping facility can also be derived in any of a variety of ways. As one example, the identifying information can be gleaned from traceable tender information corresponding to purchases made by consumers at the retail shopping facility. As another example, the identifying information can be obtained from receipt-based information provided directly by customers (via, for example, an app provided by the enterprise that operates the retail shopping facility).

By one approach the mobile analytics information can be used in conjunction with information regarding partiality vectors for customers as well as vectorized characterizations for each of a plurality of products when identifying the aforementioned specific customer-based actions to facilitate.

So configured, these teachings greatly facilitate the value of mobile analytics information and provide a substantive basis for real-world actions that can significantly better daily circumstances for customers of a retail shopping facility.

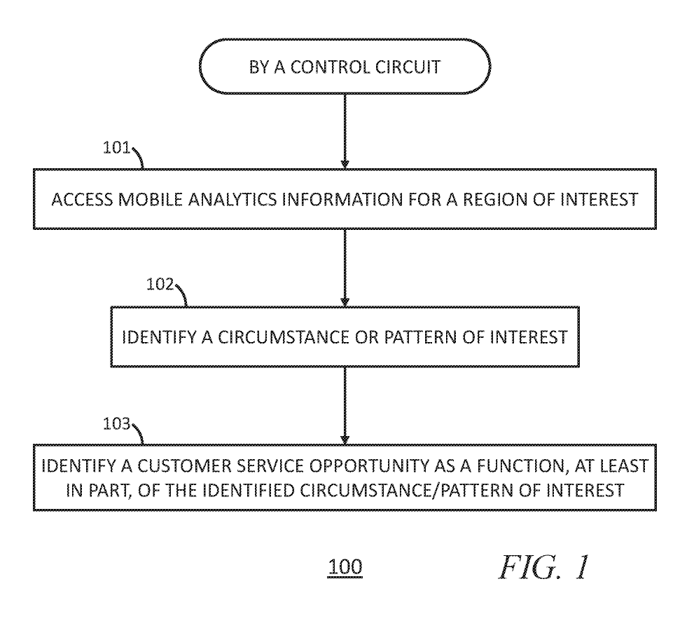

These and other benefits may become clearer upon making a thorough review and study of the following detailed description. Referring now to the drawings, and in particular to FIG. 1, an illustrative process 100 that is compatible with many of these teachings will now be presented. In this description it will be presumed that a control circuit of choice carries out one, some, or all of the described activities that comprise this process 100. Specific examples of such a control circuit are provided further below.

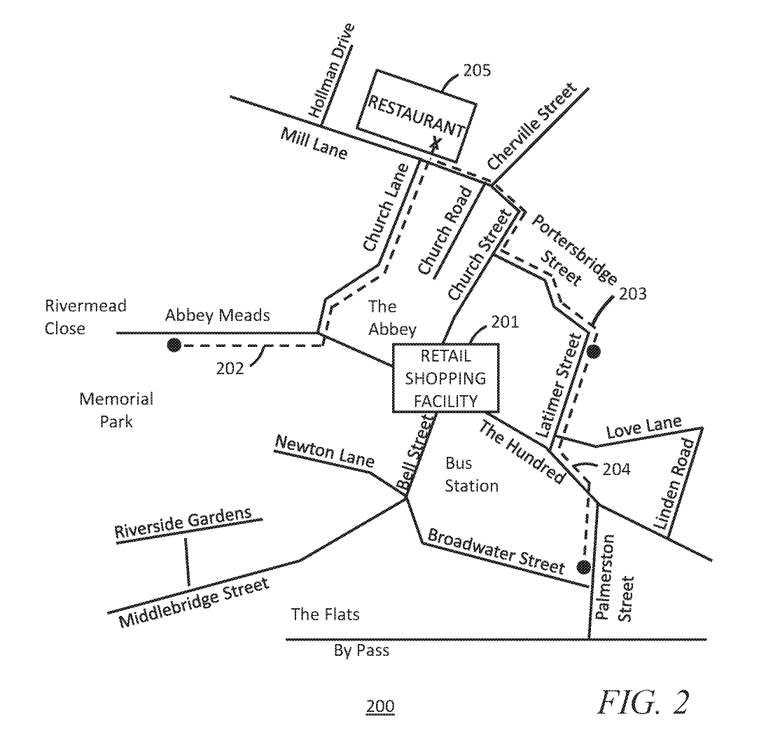

At block 101 this process 100 provides for accessing mobile analytics information for a region of interest. FIG. 2 provides a simple illustrative example in these regards. In particular, FIG. 2 presents an illustration of a street map for a region of interest 200. In this example a retail shopping facility 201 appears at the center of the region of interest 200.

As used herein, the expression “retail shopping facility” will be understood to refer to a facility that comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

In this simple example the mobile analytics information illustrates tracking information for three separate mobile devices (such as so-called smart phones). These three separate tracks are denoted by reference numerals 202-204. A dark circle denotes a point of origin and an “X” character denotes a terminus point, both as correspond to a particular journey for a particular mobile device. (It shall be understood that these conventions are used here for the sake of illustration and that any number of graphic approaches can be readily utilized to convey identical or similar information as desired.)

Mobile analytics information can include, inferentially or explicitly, temporal information as well. In the illustration of FIG. 2, for example, the information displayed may represent a particular window of time such as 10 minutes, one hour, or one day (to note but a few possibilities in these regards). If desired, time information can be associated with one or more parts of an individually-displayed track (such as a start time associated with a point of origin or an arrival time associated with a terminus point).

The presentation of such information can be provided to a user on a real-time basis if desired or can be historical in nature if desired (for example, by displaying information from a previous day and without showing information that is more up to the minute). It will also be understood that color or other graphic affectations can be utilized as desired to impart information. For example, different colors can be utilized to disambiguate amongst a plurality of displayed devices. As another example, one color can serve to identify movement during one time of the day (such as during the morning hours) while another color identifies movement during a different time of the day (such as during the afternoon hours). And as yet another example, one color could indicate movement away from a region of interest while another, different color could indicate movement towards a region of interest.

The information presented in FIG. 2 includes only three devices/tracks. Only this limited number of devices are presented here for the sake of simplicity and clarity. In a typical application setting, dozens, hundreds, or even thousands of devices/tracks may be simultaneously presented on such a display/map. Accordingly, some mobile analytics platforms may provide the user with an opportunity to select and sort amongst a plurality of displayed devices/tracks to better facilitate the user's understanding and analysis of the displayed information.

With continued reference to both FIGS. 1 and 2, at block 102 this process 100 provides for identifying within the mobile analytics information a circumstance or pattern of interest. In the simple example of FIG. 2, the circumstance/pattern constitutes identifying restaurants being visited by persons that appear to live or work within the region of interest 200. In this example the three devices/tracks 202-204 all have a point of origin within the region of interest 200 and all include a stop at the same restaurant 205. (Other likely available information regarding other travels by these devices, including where these devices went after visiting the restaurant 205, are not shown here for the sake of clarity.)

At block 103 this process 100 provides for identifying a customer service opportunity as a function, at least in part, of the identified circumstance/pattern of interest. In the present example the circumstance/pattern of interest suggests that persons living within the region of interest 200 (and hence within convenient access to the retail shopping facility 201) enjoy eating meals at this particular restaurant 205. Upon further investigating this particular restaurant 205, it may be determined, for example, that this restaurant 205 offers a particular kind of ethnic food. In that case, this process 100 may provide for stocking the retail shopping facility 201 with food items (including meats, produce, spices, and so forth) that typify (perhaps uniquely) the aforementioned ethnic food but which might not otherwise be ordinarily carried by this retail shopping facility.

These teachings will accommodate a wide variety of circumstances and/or patterns of interest. Examples in these regards include but are not limited to traffic patterns (for example, times when particular streets or intersections are especially heavy with traffic or relatively clear of traffic), apparent gatherings of people at non-retail venues, travel patterns for apparent commuters in the region of interest (including, for example, commuting patterns driven in part by the availability or unavailability of work-time flexibility such that employees leave their homes for work over wider or narrower time windows), residential patterns (for example, patterns regarding where people live relative to their employer), traffic patterns regarding people who are likely sharing a same road at the same time, travel patterns of students traveling between school and home, and so forth.

Similarly, these teachings will also accommodate a wide variety of resultant customer service opportunities. Examples in these regards include but are not limited to items to be offered as complementary samples at a retail shopping facility or at another location suggested by the mobile analytics information, items to be offered at food trucks or other mobile offerings platforms, sponsorship opportunities for the retail shopping facility, traveler-dependent content to be displayed via roadside electronic billboards, and so forth.

In the examples above the mobile analytics information presumably provides no information that the retail shopping facility can utilize to directly identify a user or other entity that corresponds to any of the tracked mobile devices. Notwithstanding the anonymous nature of the mobile analytics information, as shown above that information can nevertheless provide many helpful insights and clues to improve product and service offerings by such a retail shopping facility.

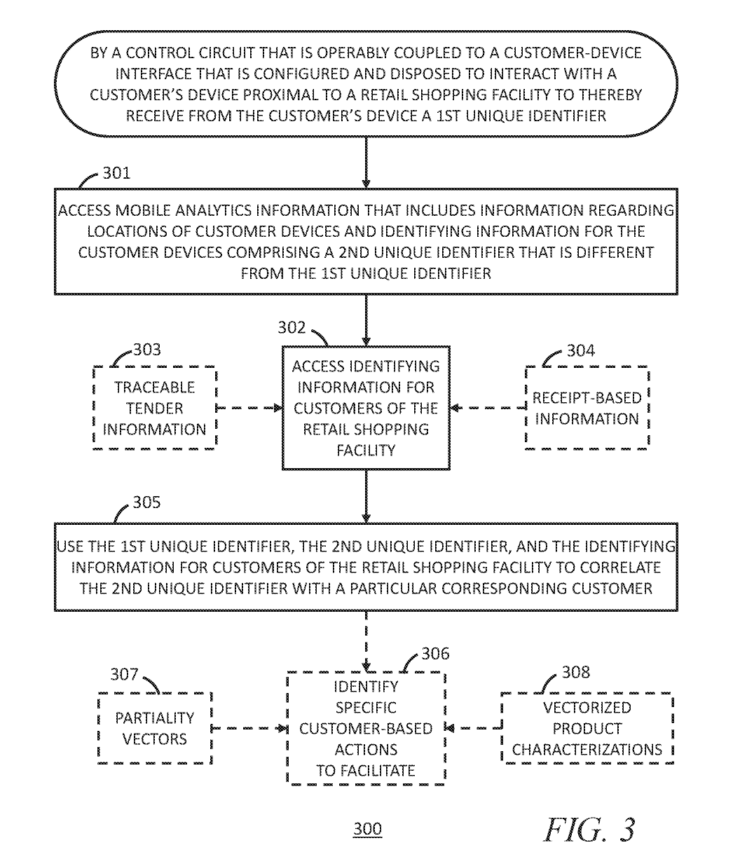

Referring now to FIG. 3, these teachings also contemplate an approach that permits anonymous mobile analytics information to be employed, at least in part, to identify a particular device user and to use that identification to greatly personalize the customer service opportunity that may be provided to such a customer. In a typical application setting this personalization is undertaken subject to the permission and possible other stipulations and requirements of the customer.

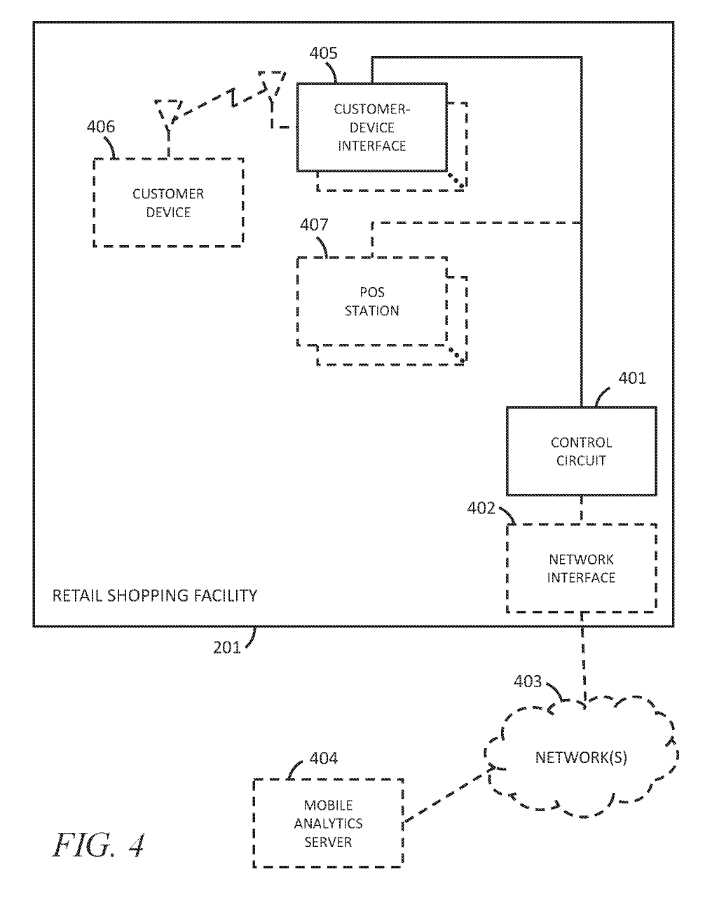

In particular, FIG. 3 presents a process 300 that can be carried out by a control circuit that operably couples to a customer-device interface that interacts with a customer's device proximal to a retail shopping facility to thereby receive a unique identifier from the customer's device. FIG. 4 provides an illustrative example in this regard.

In this example a retail shopping facility 201 includes a control circuit 401. Being a “circuit,” this control circuit 401 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 401 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 401 is configured (for example, by using corresponding programming as will be well understood by those skilled in the art) to carry out one or more of the steps, actions, and/or functions described herein.

By one optional approach the control circuit 401 operably couples to a memory (not shown). This memory may be integral to the control circuit 401 or can be physically discrete (in whole or in part) from the control circuit 401 as desired. This memory can also be local with respect to the control circuit 401 (where, for example, both share a common circuit board, chassis, power supply, and/or housing) or can be partially or wholly remote with respect to the control circuit 401 (where, for example, the memory is physically located in another facility, metropolitan area, or even country as compared to the control circuit 401).

This memory can serve, for example, to non-transitorily store computer instructions that, when executed by the control circuit 401, cause the control circuit 401 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

By one approach the control circuit 401 optionally operably couples to a network interface 402. So configured the control circuit 401 can communicate with other network elements (such as but not limited to a mobile analytics server 404 that provides mobile analytics information per these teachings) using one or more intervening networks via the network interface 402. Network interfaces, including both wireless and non-wireless platforms, are well understood in the art and require no particular elaboration here. These teachings will support using any of a wide variety of networks including but not limited to the Internet (i.e., the global network of interconnected computer networks that use the Internet protocol suite (TCP/IP)).

In this illustrative example the control circuit 401 operably couples to at least one customer-device interface 405. The customer-device interface can comprise, by one approach, a wireless interface such as but not limited to a Wi-Fi access point and/or a Bluetooth transceiver. (As used herein “Wi-Fi” will be understood to refer to a technology that allows electronic devices to connect to a wireless Local Area Network (LAN) (generally using the 2.4 gigahertz and 5 gigahertz radio bands). More particularly, “Wi-Fi” refers to any Wireless Local Area Network (WLAN) product based on interoperability consistent with the Institute of Electrical and Electronics Engineers' (IEEE) 802.11 standards. Also as used herein, “Bluetooth” will be understood to refer to a wireless communications standard managed by the Bluetooth Special Interest Group. The Bluetooth standard makes use of frequency-hopping spread spectrum techniques and typically provides for only a very short range wireless connection (typically offering a range of only about ten meters in many common application settings). This standard comprises a packet-based approach that relies upon a so-called master-slave paradigm where a master device can support only a limited (plural) number of subservient devices.)

The customer-device interface 405 is configured and disposed to interact with a customer's device 406 proximal to the retail shopping facility 201. In a typical application setting this interaction will constitute a wireless communication of information. As used herein, the customer's device 406 is “proximal” to the retail shopping facility 201 when the customer's device 406 is within the retail shopping facility 201 and/or when the customer's device 406 is within a short distance of the retail shopping facility 201 (such as, for example, 1 meter, 5 meters, 10 meters, 30 meters, or some other minimal distance of choice).

As already noted above, the customer-device interface serves, at least in part, to receive from the customer's device 406 a first unique identifier. Generally speaking this first unique identifier does not directly identify the user of the customer's device 406. For example, the first unique identifier is not the full or abridged name of the customer nor a full or abridged name of a personally-selected customer avatar.

Instead, and by one approach, the first unique identifier comprises a Media Access Control (MAC) address for the customer's device 406. A MAC address of a computer is a unique identifier assigned to network interfaces for communications at the data link layer of a network segment. MAC addresses are used as a network address for many IEEE 802 network technologies, including Ethernet, Wi-Fi, and often Bluetooth. Logically, MAC addresses are used in the media access control protocol sublayer of the OSI reference model. MAC addresses are most often assigned by the manufacturer of a Network Interface Controller (NIC) and are stored in its hardware, such as the card's read-only memory or some other firmware mechanism. If assigned by the manufacturer, a MAC address usually encodes the manufacturer's registered identification number and may be referred to as the burned-in address. It may also be known as an Ethernet hardware address, hardware address, or physical address. MAC addresses are formed according to the rules of one of three numbering name spaces managed by the Institute of Electrical and Electronics Engineers, (i.e., MAC-48, EUI-48, and EUI-64).

As one illustrative example, the customer device 406 may comprise a so-called smart phone having Wi-Fi and/or Bluetooth conductivity capabilities. When the customer device 406 is within a range of the customer-device interface 405, these two elements may automatically communicate with one another during which communication the customer device 406 provides its MAC address to the customer-device interface 405. The customer-device interface 405 then supplies that MAC address to the control circuit 401.

As illustrated in FIG. 4, the retail shopping facility 201 may also optionally include one or more so-called point of sale (POS) stations 407. A POS station 407 is where a customer completes a retail transaction. Typically, the retailer calculates the amount owed by the customer and indicates that amount to the customer. The POS station 407 also serves as the point where the customer pays the retailer in exchange for goods or after provision of a service. After receiving payment, the retailer may issue a receipt (hard copy or otherwise) for the transaction. The POS station 407 may be directly attended by an associate of the retail shopping facility 201 or may be partially or wholly automated.

In many cases the customer's payment includes traceable tender information such as the customer's name or an identifier that can be readily and directly linked to the customer's name. In this example the control circuit 401 is configured to access at least some traceable tender information from a POS station 407 corresponding to purchases made by customers at the retail shopping facility 201.

With continued reference to FIGS. 3 and 4, this process 300 provides, at block 301, for having the control circuit 401 access mobile analytics information (sourced, for example, by the aforementioned mobile analytics server 404). This mobile analytics information includes information regarding locations of customer devices and identifying information for the customer devices comprising a second unique identifier that is different from the aforementioned first unique identifier.

The received information regarding locations of customer devices can vary as described above. By one approach the information provides mapped tracking information for a plurality of customer devices within some report region over some relevant period of time. Different colors can be used to parse the informational content and graphic icons can be utilized to indicate times, events, and other parameters of interest as desired.

Generally speaking, those who provide mobile analytics information do not provide that information in conjunction with any content that specifically identifies a particular user. For example, the provided content typically lacks user names or other user monikers, telephone numbers, email addresses, or the like. On the other hand, mobile analytics information often includes an identifier for each track and/or displayed device in order to help the analyst disambiguate the depicted information. The second unique identifier may therefore comprise, for example, a mobile device Electronic Serial Number (ESN), a mobile device International Mobile Equipment Identity (IMEI) number, or a (possibly random) number/identifier assigned by a wireless-communications service provider and/or the party providing the mobile analytics information.

It may be noted that the second unique identifier may be displayed on a map that presents the mobile analytics tracking data. By another approach the second unique identifier may be revealed by effecting some selection action with respect to a particular track (for example, double-clicking on a particular track). The present teachings are relatively insensitive to how the second unique identifiers are included with the received mobile analytics information.

At block 302 the control circuit 401 accesses identifying information for customers of the retail shopping facility 201. By one optional approach this identifying information may be obtained from traceable content information 303 that corresponds to purchases made by the customers at the retail shopping facility 201 as captured by, for example, the aforementioned POS station 407. For example, a customer's name is typically included with other information presented at the POS station 407 when paying for a purchase using a credit card or a debit card.

By another optional approach, in lieu of the foregoing or in combination therewith, the identifying information may be received along with other receipt-based information 304 that is provided directly by customers. Such receipt-based information 304 can also serve to correlate purchases made by customers at the retail shopping facility 201 with their corresponding identifying customer information. A customer can be enabled to directly provide such information using, for example, a smart phone app provided or otherwise supported by the enterprise that operates the retail sales facility 201. Such an app can provide an opportunity for the customer to maintain a virtual record of their shopping or can, for example, serve as a way for the customer to have the enterprise check and ensure that prices paid by the customer meet some pricing guarantee of the enterprise.

At block 305, the control circuit 401 uses the first unique identifier, the second unique identifier, and the identifying information for customers of the retail shopping facility 201 to statistically (or, perhaps more accurately, by the process of elimination) correlate one of the second unique identifiers with a particular corresponding customer.

More specifically, for a given block of time the control circuit 401 knows which customer devices are likely at the retail shopping facility 201 by referencing the mobile analytics information. In particular, the control circuit 401 knows particular second unique identifiers that have arrived at the retail shopping facility 201. For that same block of time the control circuit 401 also knows which customer devices have presented the aforementioned first unique identifier at the retail shopping facility 201. And lastly, and again for that same block of time, the control circuit 401 further knows the names of (at least many) specific customers who made purchases at the retail shopping facility 201.

The control circuit 401 uses the foregoing information to accurately correlate a particular customer to a particular anonymized mobile device identifier as used with the mobile analytics information, in many cases, as a result of only a single customer visit to the retail shopping facility 201. In other cases there may be sufficient customer/device activity to create some ambiguity in these regards after only a single customer visit. In that case, the ambiguity can be relieved and an accurate correlation made after X number of additional visits by a particular customer to the retail shopping facility 201 (where X is an integer of 1 or greater).

So configured, and particularly over time, the control circuit 401 can personalize the previously anonymized mobile analytics information to thereby associate particular customers with particular identifiers for various mobile devices/tracks. Accordingly, the control circuit 401 can utilize that personalization when analyzing later-received mobile analytics information in various ways to benefit the identified customers.

Optional block 306 provides some illustrative examples in these regards. Here, the control circuit 401 uses the now-personalized mobile analytics information to identify specific customer-based actions to facilitate. In particular, and as one example in these regards, the control circuit 401 can employ partiality vectors 307 that correspond to the identified customer and vectorized product characterizations 308 in combination with information regarding where the now-identified customer travels, visits, shops, and otherwise engages themselves to identify particular products and/or services to make available to the customer.

Further, generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

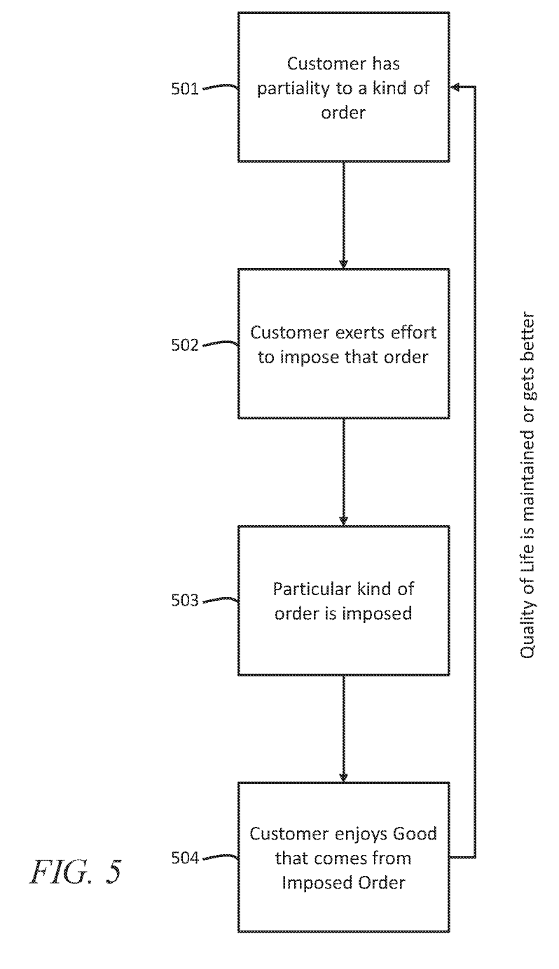

FIG. 5 provides a simple illustrative example in these regards. At block 501 it is understood that a particular person has a partiality (to a greater or lesser extent) to a particular kind of order. At block 502 that person willingly exerts effort to impose that order to thereby, at block 503, achieve an arrangement to which they are partial. And at block 504, this person appreciates the “good” that comes from successfully imposing the order to which they are partial, in effect establishing a positive feedback loop.

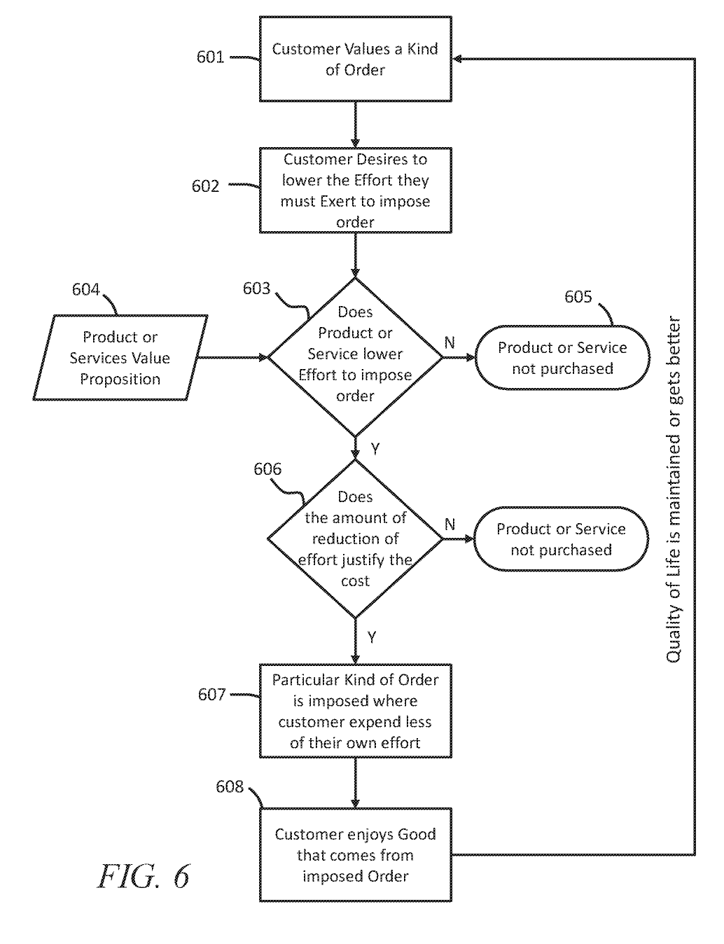

Understanding these partialities to particular kinds of order can be helpful to understanding how receptive a particular person may be to purchasing a given product or service. FIG. 6 provides a simple illustrative example in these regards. At block 601 it is understood that a particular person values a particular kind of order. At block 602 it is understood (or at least presumed) that this person wishes to lower the effort (or is at least receptive to lowering the effort) that they must personally exert to impose that order. At decision block 603 (and with access to information 604 regarding relevant products and or services) a determination can be made whether a particular product or service lowers the effort required by this person to impose the desired order. When such is not the case, it can be concluded that the person will not likely purchase such a product/service 605 (presuming better choices are available).

When the product or service does lower the effort required to impose the desired order, however, at block 606 a determination can be made as to whether the amount of the reduction of effort justifies the cost of purchasing and/or using the proffered product/service. If the cost does not justify the reduction of effort, it can again be concluded that the person will not likely purchase such a product/service 605. When the reduction of effort does justify the cost, however, this person may be presumed to want to purchase the product/service and thereby achieve the desired order (or at least an improvement with respect to that order) with less expenditure of their own personal effort (block 607) and thereby achieve, at block 608, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

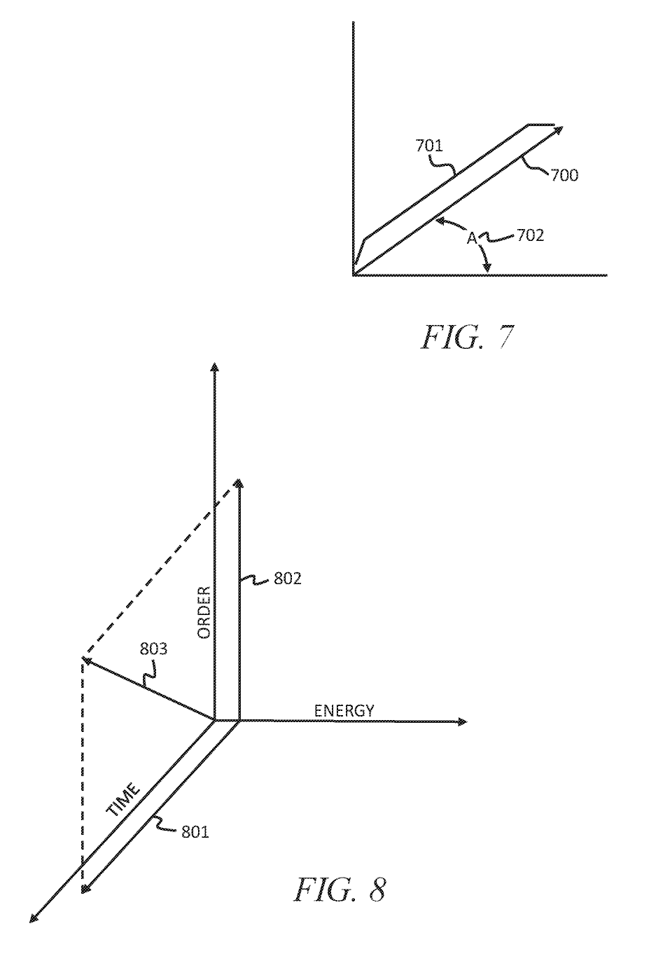

FIG. 7 provides some illustrative examples in these regards. By one approach the vector 700 has a corresponding magnitude 701 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 701, the greater the strength of that belief and vice versa. Per another example, the vector 700 has a corresponding angle A 702 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 8 presents a space graph that illustrates many of the foregoing points. A first vector 801 represents the time required to make such a wristwatch while a second vector 802 represents the order associated with such a device (in this case, that order essentially represents the skill of the craftsman). These two vectors 801 and 802 in turn sum to form a third vector 803 that constitutes a value vector for this wristwatch. This value vector 803, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

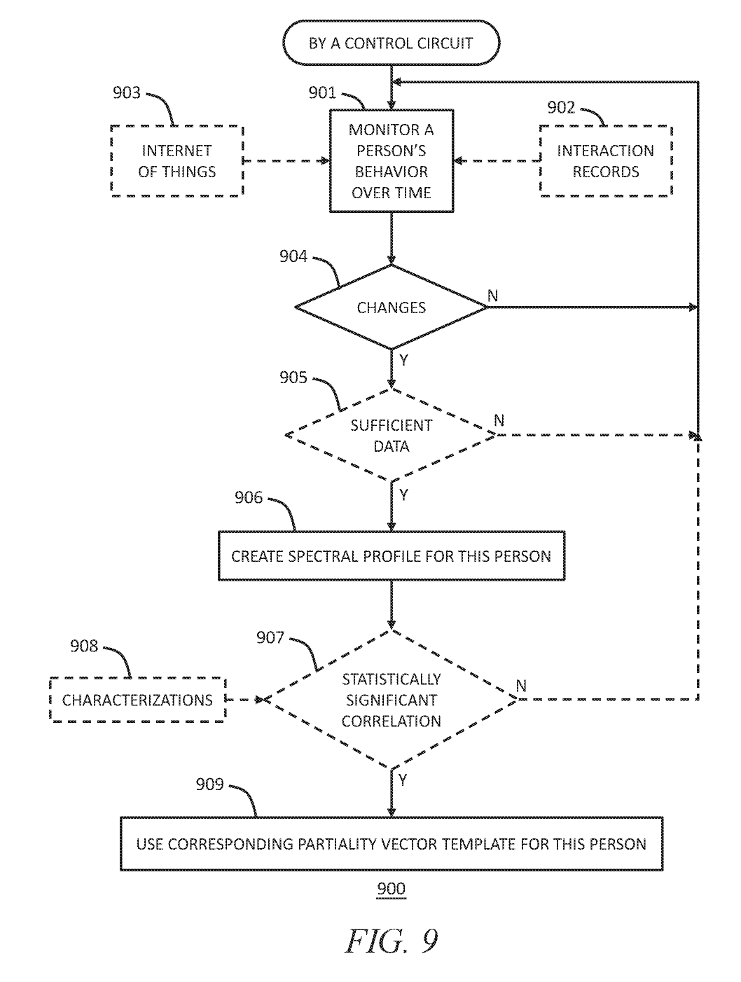

FIG. 9 presents a process 900 that illustrates yet another approach in these regards. For the sake of an illustrative example it will be presumed here that a control circuit of choice (with useful examples in these regards being presented further below) carries out one or more of the described steps/actions.

At block 901 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 902 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 902 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 903. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 900 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 904 this process 900 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 905 this process 900 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

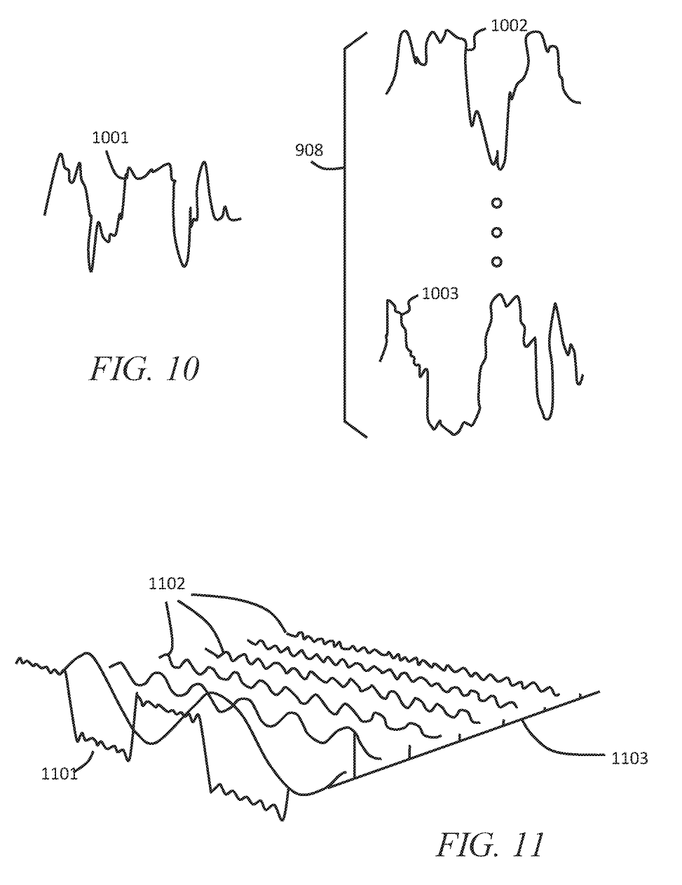

At block 907 this process 900 uses these detected changes to create a spectral profile for the monitored person. FIG. 10 provides an illustrative example in these regards with the spectral profile denoted by reference numeral 1001. In this illustrative example the spectral profile 1001 represents changes to the person's behavior over a given period of time (such as an hour, a day, a week, or some other temporal window of choice). Such a spectral profile can be as multidimensional as may suit the needs of a given application setting.

At optional block 907 this process 900 then provides for determining whether there is a statistically significant correlation between the aforementioned spectral profile and any of a plurality of like characterizations 908. The like characterizations 908 can comprise, for example, spectral profiles that represent an average of groupings of people who share many of the same (or all of the same) identified partialities. As a very simple illustrative example in these regards, a first such characterization 1002 might represent a composite view of a first group of people who have three similar partialities but a dissimilar fourth partiality while another of the characterizations 1003 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 908 are based and/or the amount of data and/or the duration of time over which data is available for the monitored person.

Referring now to FIG. 11, by one approach the selected characterization (denoted by reference numeral 1101 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 1101 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 11 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 11) in the same sense as, for example, a radio or acoustic wave, it will nevertheless be understood that such a behavioral characterization 1101 can itself be broken down into a plurality of sub-waves 1102 that, when summed together, equal or at least approximate to some satisfactory degree the behavioral characterization 1101 itself. (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 1103 wherein the X axis represents frequency and the Y axis represents the magnitude of the response of the monitored person at each frequency/sub-wave of interest.

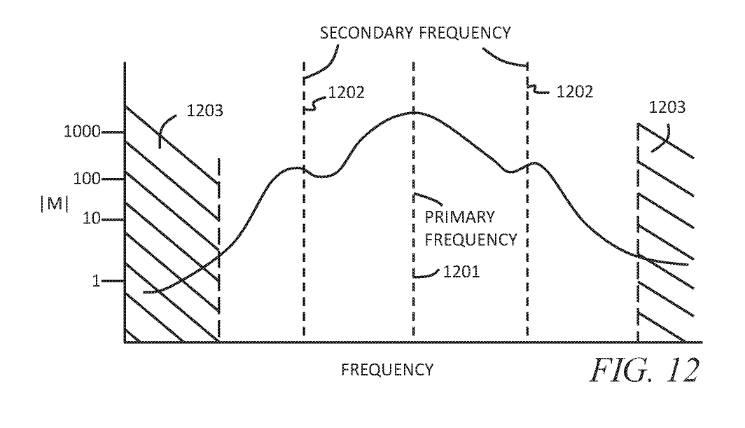

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 12, for many people the spectral profile of the individual person will exhibit a primary frequency 1201 for which the greatest response (perhaps many orders of magnitude greater than other evident frequencies) to life is exhibited and apparent. In addition, the spectral profile may also possibly identify one or more secondary frequencies 1202 above and/or below that primary frequency 1201. (It may be useful in many application settings to filter out more distant frequencies 1203 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of j ob, promotion, and so forth).

In any event, by knowing a priori the particular partialities (and corresponding strengths) that underlie the particular characterization 1101, those partialities can be used as an initial template for a person whose own behaviors permit the selection of that particular characterization 1101. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

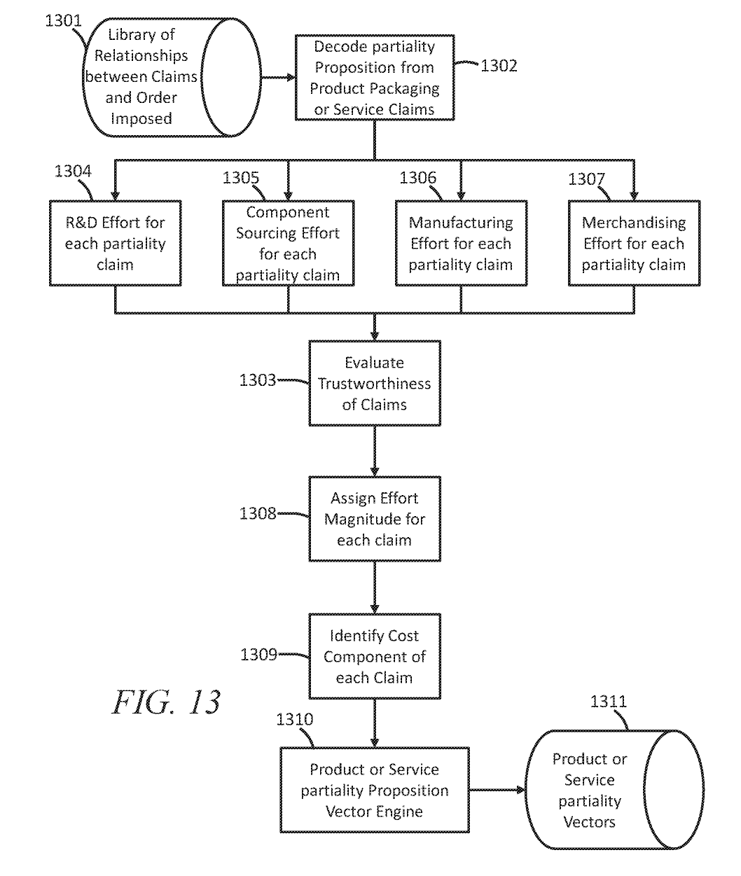

FIG. 13 presents one non-limiting illustrative example in these regards. The illustrated process presumes the availability of a library 1301 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 1302 this process provides for decoding one or more partiality propositions from specific product packaging (or service claims). For example, the particular textual/graphics-based claims presented on the packaging of a given product can be used to access the aforementioned library 1301 to identify one or more corresponding imposed orders from which one or more corresponding partialities can then be identified.

At block 1303 this process provides for evaluating the trustworthiness of the aforementioned claims. This evaluation can be based upon any one or more of a variety of data points as desired. FIG. 13 illustrates four significant possibilities in these regards. For example, at block 1304 an actual or estimated research and development effort can be quantified for each claim pertaining to a partiality. At block 1305 an actual or estimated component sourcing effort for the product in question can be quantified for each claim pertaining to a partiality. At block 1306 an actual or estimated manufacturing effort for the product in question can be quantified for each claim pertaining to a partiality. And at block 1307 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 1308 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 1309 this process provides for identifying a cost component of each claim, this cost component representing a monetary value. At block 1310 this process can use the foregoing information with a product/service partiality propositions vector engine to generate a library 1311 of one or more corresponding partiality vectors for the processed products/services.

Such a library can then be used as described herein in conjunction with partiality vector information for various persons to identify, for example, products/services that are well aligned with the partialities of specific individuals.

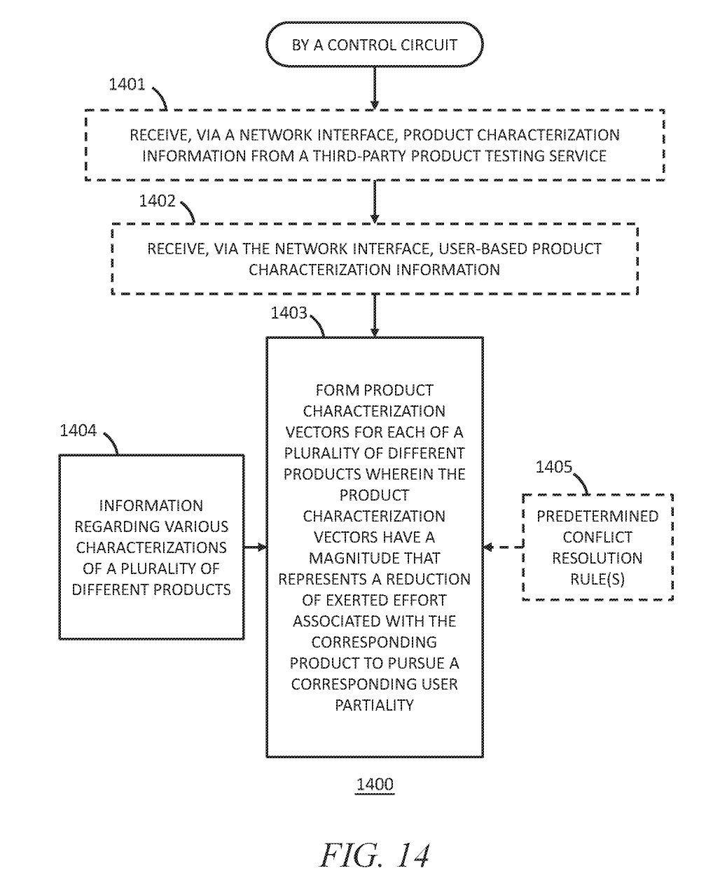

FIG. 14 provides another illustrative example in these same regards and may be employed in lieu of the foregoing or in total or partial combination therewith. Generally speaking, this process 1400 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 14, this process 1400 can be carried out by a control circuit of choice. Specific examples of control circuits are provided elsewhere herein.

As described further herein in detail, this process 1400 makes use of information regarding various characterizations of a plurality of different products. These teachings are highly flexible in practice and will accommodate a wide variety of possible information sources and types of information. By one optional approach, and as shown at optional block 1401, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1402, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1400 provides for accessing (see block 1404) information regarding various characterizations of each of a plurality of different products. This information 1404 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1404 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1403 the control circuit uses the foregoing information 1404 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1404. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1405 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1404 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

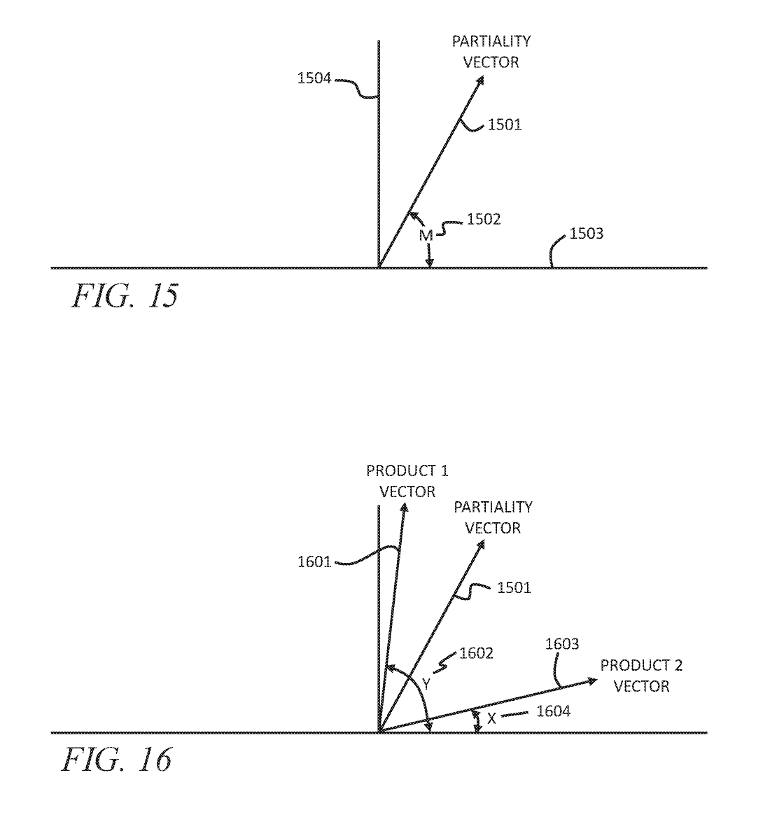

As noted above, the magnitude corresponding to a particular partiality vector for a particular person can be expressed by the angle of that partiality vector. FIG. 15 provides an illustrative example in these regards. In this example the partiality vector 1501 has an angle M 1502 (and where the range of available positive magnitudes range from a minimal magnitude represented by 0° (as denoted by reference numeral 1503) to a maximum magnitude represented by 90° (as denoted by reference numeral 1504)). Accordingly, the person to whom this partiality vector 1501 pertains has a relatively strong (but not absolute) belief in an amount of good that comes from an order associated with that partiality.

FIG. 16, in turn, presents that partiality vector 1501 in context with the product characterization vectors 1601 and 1603 for a first product and a second product, respectively. In this example the product characterization vector 1601 for the first product has an angle Y 1602 that is greater than the angle M 1502 for the aforementioned partiality vector 1501 by a relatively small amount while the product characterization vector 1603 for the second product has an angle X 1604 that is considerably smaller than the angle M 1502 for the partiality vector 1501.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1601 with the partiality vector 1501 will be larger than the resultant scaler value for the vector dot product of the product 2 vector 1603 with the partiality vector 1501. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·Ply) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½-∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥, but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

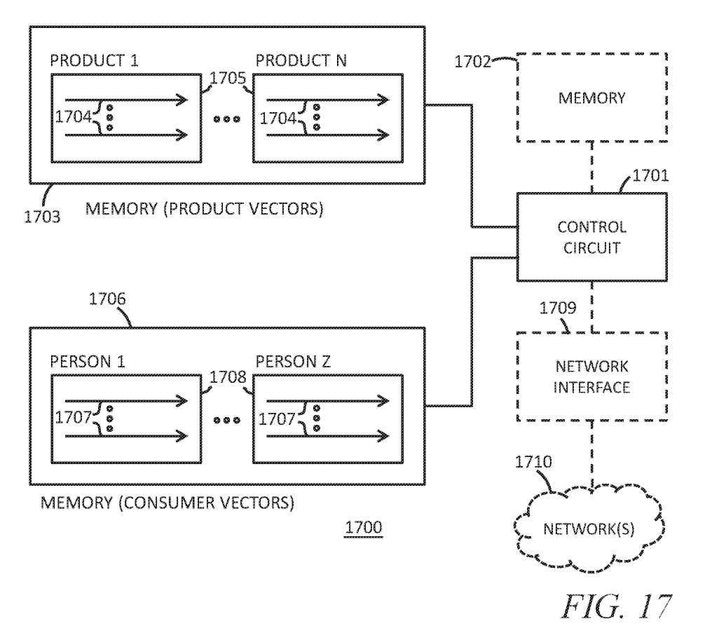

FIG. 17 presents an illustrative apparatus 1700 for conducting, containing, and utilizing the foregoing content and capabilities. In this particular example, the enabling apparatus 1700 includes a control circuit 1701. Being a “circuit,” the control circuit 1701 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1701 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1701 is configured (for example, by using corresponding programming as will be well understood by those skilled in the art) to carry out one or more of the steps, actions, and/or functions described herein.

By one optional approach the control circuit 1701 operably couples to a memory 1702. This memory 1702 may be integral to the control circuit 1701 or can be physically discrete (in whole or in part) from the control circuit 1701 as desired. This memory 1702 can also be local with respect to the control circuit 1701 (where, for example, both share a common circuit board, chassis, power supply, and/or housing) or can be partially or wholly remote with respect to the control circuit 1701 (where, for example, the memory 1702 is physically located in another facility, metropolitan area, or even country as compared to the control circuit 1701).

This memory 1702 can serve, for example, to non-transitorily store the computer instructions that, when executed by the control circuit 1701, cause the control circuit 1701 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1702 or, as illustrated, in a separate memory 1703 are the vectorized characterizations 1704 for each of a plurality of products 1705 (represented here by a first product through an Nth product where “N” is an integer greater than “1”). In addition, and again either stored in this memory 1702 or, as illustrated, in a separate memory 1706 are the vectorized characterizations 1707 for each of a plurality of individual persons 1708 (represented here by a first person through a Zth person wherein “Z” is also an integer greater than “1”).

In this example the control circuit 1701 also operably couples to a network interface 1709. So configured the control circuit 1701 can communicate with other elements (both within the apparatus 1700 and external thereto) via the network interface 1709. Network interfaces, including both wireless and non-wireless platforms, are well understood in the art and require no particular elaboration here. This network interface 1709 can compatibly communicate via whatever network or networks 1710 may be appropriate to suit the particular needs of a given application setting. Both communication networks and network interfaces are well understood areas of prior art endeavor and therefore no further elaboration will be provided here in those regards for the sake of brevity.

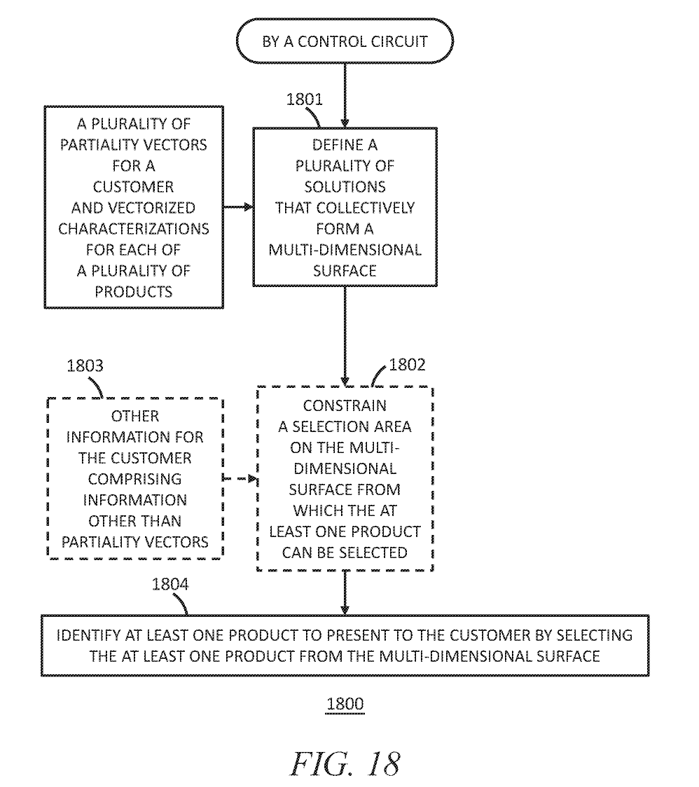

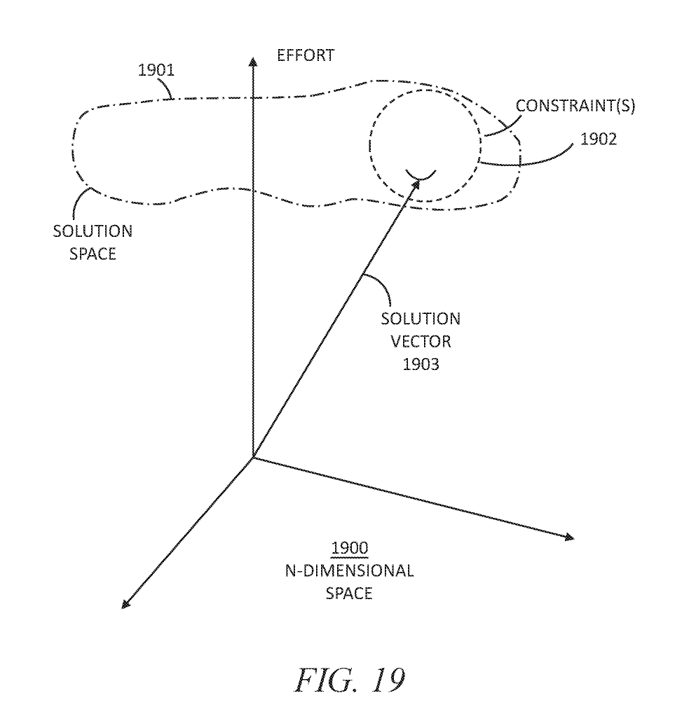

By one approach, and referring now to FIG. 18, the control circuit 1701 is configured to use the aforementioned partiality vectors 1707 and the vectorized product characterizations 1704 to define a plurality of solutions that collectively form a multidimensional surface (per block 1801). FIG. 19 provides an illustrative example in these regards. FIG. 19 represents an N-dimensional space 1900 and where the aforementioned information for a particular customer yielded a multi-dimensional surface denoted by reference numeral 1901. (The relevant value space is an N-dimensional space where the belief in the value of a particular ordering of one's life only acts on value propositions in that space as a function of a least-effort functional relationship.)

Generally speaking, this surface 1901 represents all possible solutions based upon the foregoing information. Accordingly, in a typical application setting this surface 1901 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 18 and 19, at optional block 1802 the control circuit 1701 can be configured to use information for the customer 1803 (other than the aforementioned partiality vectors 1707) to constrain a selection area 1902 on the multi-dimensional surface 1901 from which at least one product can be selected for this particular customer. By one approach, for example, the constraints can be selected such that the resultant selection area 1902 represents the best 95th percentile of the solution space. Other target sizes for the selection area 1902 are of course possible and may be useful in a given application setting.

The aforementioned other information 1803 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1902), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1804 the control circuit 1701 can then identify at least one product to present to the customer by selecting that product from the multi-dimensional surface 1901. In the example of FIG. 19, where constraints have been used to define a reduced selection area 1902, the control circuit 1701 is constrained to select that product from within that selection area 1902. For example, and in accordance with the description provided herein, the control circuit 1701 can select that product via solution vector 1903 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1701 may respond per these teachings to learning that the customer is planning a party that will include seven other invited individuals. The control circuit 1701 may therefore be looking to identify one or more particular beverages to present to the customer for consideration in those regards. The aforementioned partiality vectors 1707 and vectorized product characterizations 1704 can serve to define a corresponding multi-dimensional surface 1901 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1902 to beverages that contain no alcohol. As another example in these regards, the control circuit 1701 may have objective information that the party is to be held in a state park that prohibits alcohol and may therefore similarly constrain the available selection area 1902 to beverages that contain no alcohol.

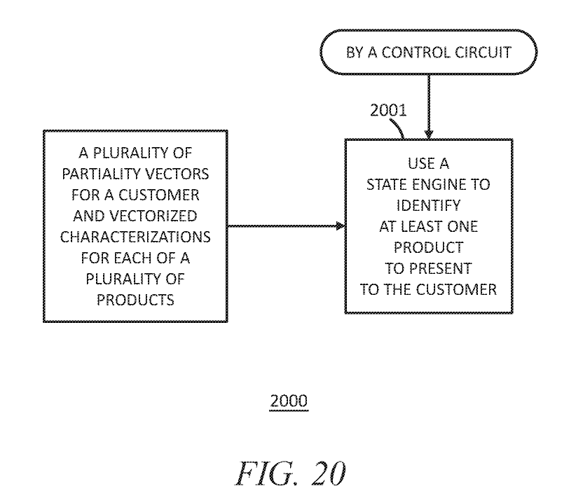

As described above, the aforementioned control circuit 1701 can utilize information including a plurality of partiality vectors for a particular customer along with vectorized product characterizations for each of a plurality of products to identify at least one product to present to a customer. By one approach 2000, and referring to FIG. 20, the control circuit 1701 can be configured as (or to use) a state engine to identify such a product (as indicated at block 2001). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

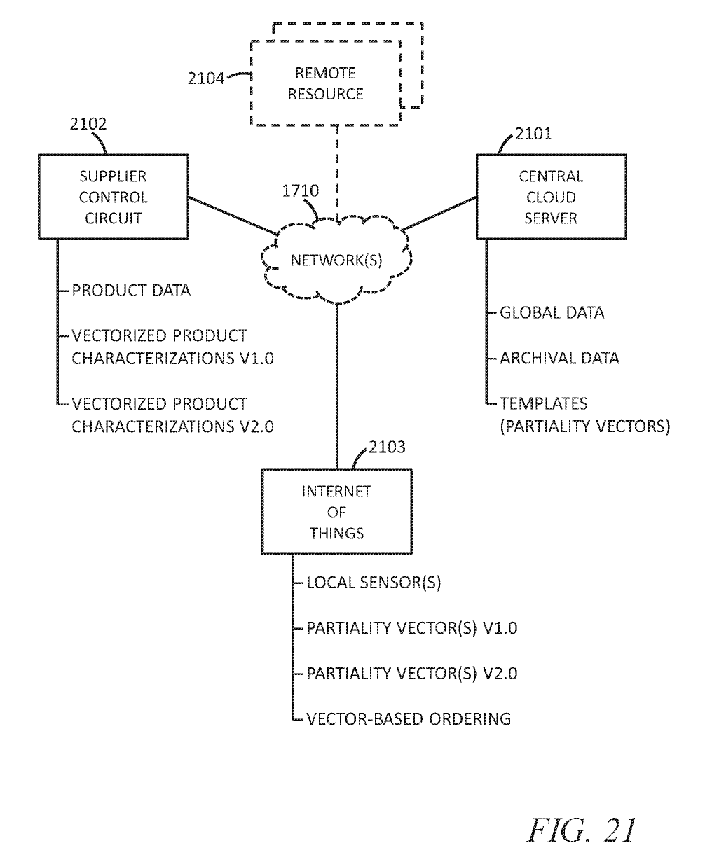

It will be appreciated that the apparatus 1700 described above can be viewed as a literal physical architecture or, if desired, as a logical construct. For example, these teachings can be enabled and operated in a highly centralized manner (as might be suggested when viewing that apparatus 1700 as a physical construct) or, conversely, can be enabled and operated in a highly decentralized manner. FIG. 21 provides an example as regards the latter.

In this illustrative example a central cloud server 2101, a supplier control circuit 2102, and the aforementioned Internet of Things 2103 communicate via the aforementioned network 1710.

The central cloud server 2101 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 2101 that store identical, overlapping, or wholly distinct content.)

The supplier control circuit 2102 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 21 by the expression “vectorized product characterizations V1.0”) for a given product as well as subsequent, updated vectorized product characterizations (denoted in FIG. 21 by the expression “vectorized product characterizations V2.0”) for the same product. Such modifications may have been made by the supplier control circuit 2102 itself or may have been made in conjunction with or wholly by an external resource as desired.

The Internet of Things 2103 can comprise any of a variety of devices and components that may include local sensors that can provide information regarding a corresponding user's circumstances, behaviors, and reactions back to, for example, the aforementioned central cloud server 2101 and the supplier control circuit 2102 to facilitate the development of corresponding partiality vectors for that corresponding user. Again, however, these teachings will also support a decentralized approach. In many cases devices that are fairly considered to be members of the Internet of Things 2103 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 2102 and use that information in conjunction with local partiality vector information to facilitate the vector-based ordering.

Also, if desired, the smart phone in this example can itself modify and update partiality vectors for the corresponding user. To illustrate this idea in FIG. 21, this device can utilize, for example, information gained at least in part from local sensors to update a locally-stored partiality vector (represented in FIG. 21 by the expression “partiality vector V1.0”) to obtain an updated locally-stored partiality vector (represented in FIG. 21 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 2104. These remote resources 2104 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Accordingly, the aforementioned personalized mobile analytics information can be leveraged to help further particularize partiality vectors for a corresponding customers and can further help to develop specific customer-based actions to facilitate based upon the customer's historical and real-time locations (and the behaviors and activities suggested by those locations) and their corresponding partiality vectors.

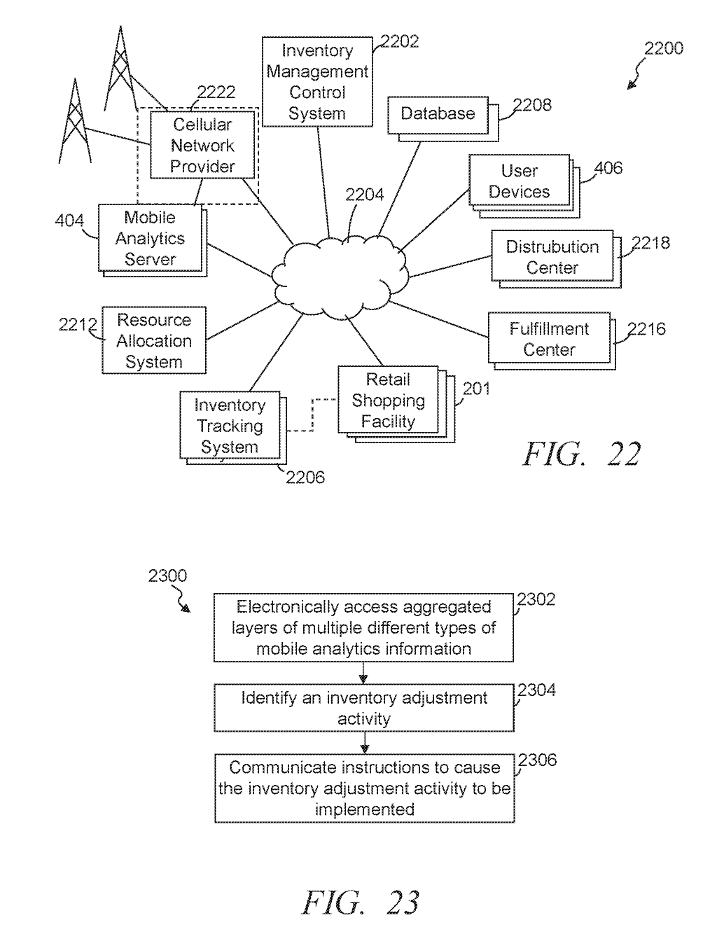

FIG. 22 illustrates a simplified block diagram of an exemplary retail product inventory distribution system 2200, in accordance with some embodiments. The retail product management system is configured to, at least in part, manage inventory within a geographic area to support customers within, arriving at, departing from and/or passing through the geographic area. The system 2200 includes one or more inventory management control systems 2202 communicatively coupled via one or more computer and/or communication networks 2204 with one or more inventory tracking systems 2206. In some embodiments, one or more of the inventory tracking systems 2206 are associated with and/or track product inventory with respect to one or more retail shopping facilities 201, product fulfillment centers 2216, product distribution centers 2218 and/or other sources of products to be sold to customers.

Typically, the retail product inventory distribution system 2200 includes and/or has access to one or more databases 2208. Further, the system may include and/or be in communication with one or more mobile analytics servers 404 that each supply one or more different types of mobile analytics information to be utilized by the inventory management control system 2202. One or more of the mobile analytics servers 404 may be implemented by and/or communicatively coupled with one or more cellular communications network providers 2222 that provide at least cellular communications network provider analytics information, and other sources of mobile analytics information (e.g., wireless network access points (e.g., Wi-Fi, Bluetooth, etc.), vehicle assistance services, satellite communication services, and/or other such analytics information sources). In some embodiments, the retail product inventory distribution system may include one or more resource allocation systems 2212.

The one or more inventory tracking systems 2206 are configured to maintain inventory count information of tens of thousands of products across at least multiple different retail shopping facilities 201. In some embodiments, one or more inventory tracking systems receive signals comprising inventory information and/or analytics information, track inventory counts of products at distribution centers that supply products to retail shopping facilities, track orders to suppliers, track orders from shopping facilities, track products shipped to distribution centers and/or shopping facilities, track other inventory information, or a combination of two or more of such inventory count information. Inventory count information includes the quantities of items of each product. The count information may be actual counts, while in some instances for some products the count information may be predicted counts and/or counts adjusted for expected and/or determined errors.

The inventory management control system 2202 is communicatively coupled via the distributed network 2204 with at least one inventory tracking system 2206 and can obtain inventory count information from the inventory tracking system to be used in determining inventory allocation and/or adjustment activity. Further, in some instances, the inventory management control system can be configured to communicate instructions and/or cause instructions to be communicated to the inventory tracking system or other inventory distribution control systems directing the reallocation of one or more products in accordance with inventory allocation and adjustment activities.

The inventory management control system is further communicatively coupled with one or more mobile analytic servers 404 and/or other sources of mobile analytics information. Typically, the inventory management control system has access to multiple different types of mobile analytics information from one or more mobile analytic servers 404. As described above, the mobile analytics information can include cellular mobile analytics information, wireless network access mobile analytics information, social media analytics information, location analytics information, movement analytics information, communications analytics information, and/or other such analytics information. Further, the mobile analytics information can include information about activities associated with multiple different user devices (e.g., smartphones, tablets, laptops, smartwatches, exercise systems, and other such devices), which are typically associated with different people, and obtained by tracking the user devices and/or receiving information from service providers utilized by the user devices (e.g., cellular service providers 2222, social media services, Internet website service providers, etc.). For example, some of the analytics information may include cellular communications network provider analytics information from one or more sources, can comprises at least information from at least one cellular network provider maintaining a cellular communication network through the physical distribution of antennas and base stations, and/or other such information from one or more other such sources. Additionally or alternatively, the analytics information may include information about activities associated with multiple different electronic user device and/or activities performed by multiple different people, and in some instances hundreds of people or more. In some instances, the retail product inventory distribution system receiving at least cellular communications network provider analytics information

Such activities can include one or more of, but not limited to, a user device being at a location and/or location information of user devices, applications utilized by users while using user devices, types of communications performed through user devices, social media usage and/or interactions, movement of user devices, other such electronic information that can be electronically detected or tracked, and other such information. Further, some of the analytics information further includes timing information and/or is tracked over time providing sequences of activities and/or movement by a subset of user devices (e.g., smartphones, tablets, laptops, smartwatches, exercise systems, and other such devices; which may be non-customer devices and customer devices 406) corresponding with people, which may or may not be a customer of a retail shopping facility. In some embodiments, access to the analytics information includes electronically accessing and utilizing aggregated mobile analytics information, and/or layers of multiple different types of mobile analytics information that correspond to activities by the user devices and/or users. Additionally, in some instances, the analytics information and/or aggregated analytics information is limited to information that is relative to a one or more geographic areas of interest (e.g., a threshold distance from a shopping facility 201, a neighborhood, a collection of neighborhoods, a city, geographic areas including and/or along travel routes (e.g., freeways, subways, train tracks, etc.), and other such geographic areas.

Often, at least some if not all of the analytics information is anonymous analytics information. As such, the anonymous analytics information does not identify individual user devices, people or users associated with the user devices or performing the corresponding activity. Further, as described above, individual user devices and users cannot be identified solely through such anonymous aggregated mobile analytics information. Additionally, in some embodiments, the inventory management control system 2202 does not attempt to identify individual user devices and/or users associated with the aggregate analytics information and instead evaluates activities in mass relative to patterns of activity. In some embodiments, the mobile analytics information is supplied by one or more mobile analytics servers 404 and identifies one or more detected patterns. Additionally or alternatively, the inventory management control system may evaluate the mobile analytics information in attempts to identify patterns of activity. Such patterns can include threshold numbers of the same or similar activities being performed, threshold number of the same or similar activities being performed within one or more threshold periods of time, one or more clusters of the same or similar activities being performed (e.g., clustered by location, within a threshold distance of each other, etc.), patterns of origins, patterns of destination or termination points, patterns of travel paths, patterns of a series of activities, and/or other such patterns. In some embodiments, the patterns may be identified through statistical evaluations of the mobile analytics information. As such, patterns may be identified based on multiple instances of an activity within a geographic area of interest and/or determined area based on a quantity of the instances of the activity, concentrations of activities within a standard deviation from an area having a threshold quantity of activity, concentrations within an average distance, identification of bell curve significance, and/or other such statistical evaluations of the mobile analytics information. Further, one or more thresholds can be applied in identifying patterns and/or filtering out individual or groups of activity information.

In some embodiments, the aggregated mobile analytics information includes multiple different types of mobile analytics information. For example, location information and timing information may be considered; location information and social media information may cooperatively be considered; cellular information, texting information timing information, and business identification information with which a user interacts (e.g., restaurant, shopping facility, etc.) may cooperatively be considered; two or more of cellular mobile analytics information, wireless network access mobile analytics information, and social media analytics information; and other such combinations of two or more types of mobile analytics information. Further, the multiple types of mobile analytics information maybe aggregated as layers of information. In some instances, the layering of information may be represented as being similar to layered Venn diagrams and/or information that can be represented as layered heat mapped information. The heat mapping allows the inventory management control system to identify concentrations of activity, patterns of activity, outlying activity, statistically relevant and/or non-relevant activity and/or other such electronic evaluation of the relatively large quantities of activity information. In some applications, the heat mapping may be illustrated and/or can be presented to an operator of the inventory management control system 2202, can represent different types of mobile analytic information based on different colors and/or different layers, and when representatively viewed the heat mapping represents relevant mobile analytics information. The represented information may include one or more or all types of mobile analytic information, it may be filtered based on one or more factors (e.g., filtered by sequences of similar activities and/or locations, filtered based on timing, filtered based on type of activity, and/or other such filtering), and other limits may be applied. Some embodiments utilize the mobile analytics information in combination with other sources of information obtained through shopping facilities and/or third party servers and/or services.

In some instances, the mobile analytics information provides representative snapshots in time of devices location and/or activity information. For example, a snapshot of a user device within a cellular network, entering a cellular network, leaving a cellular network, accessing a wireless network, interaction with a social networking service, an application active on a user device, and/or other such instances of activity. Further, the cooperative use of mobile analytics over time can provide a series of activities that represents a dynamic path of activities and/or patterns.

The inventory management control system 2202 is further configured to identify, based on one or more concentrations and/or patterns of activity determined from the aggregated multiple different types of mobile analytics information, an inventory adjustment activity to be implemented as a function of one or more of the patterns of activity relative to retail services. The retail inventory adjustment activity can be supply chain based, retail sales based, delivery based, services based, and/or other areas of inventory adjustment activity. For example, some inventory adjustment activity may include, but is not limited to, adjusting placement within one or more retail shopping facilities of items of one or more products, ordering one or more products, reducing an order of one or more products, moving items of one or more products from a first set of one or more retail shopping facilities to a second set of one or more retail shopping facilities, causing one or more products to be transported to one or more locations to be offered for sale, adjusting inventor and one or more distribution centers, offering to customers delivery at one or more locations (e.g., corresponding to movement patterns associated with a determined origin or destination area) and/or non-traditional locations (e.g., sports facilities, recreation facilities, etc.), redirecting a truck that is in-route to a different location of potential need of one or more product carried by the truck, causing a real-time notification to one or more suppliers, and other such inventory adjustment activities.

As one example, the inventory management control system may identify an inventory adjustment activity to offer delivery of products to customers at a youth soccer field based on a patterns of activity of travel to a destination that is to or within a threshold distance of the youth soccer field. As another example, based on a pattern of user devices and/or users traveling between an origin (or one of a series destination/origin pairs) of a youth soccer field on a Saturday to one or more destinations corresponding to one or more ethnic food restaurants, the inventory management control system may identify one or more inventory adjustment activities relative to offering ingredients for similar ethic foods (e.g., moving one or more ingredients to a more prominent location, increasing advertising relative to ingredients of use in making similar ethic food, etc.). As another example, the inventory management control system can be configured to identify inventory adjustment activity to cause a modification of inventory of one or more products at a retail shopping facility within a threshold distance of an origin area of a pattern of activity, at a determined destination location of a pattern of activity, at one or more retail shopping facilities along a path or travel route corresponding to a pattern of movement activity, and/or other such locations. In some instances, the inventory management control circuit identifies the inventory adjustment activity as a function of clustered movement patterns corresponding to multiple different mobile devices. The clustered movement may be identified as a pattern, in part based origins, destinations, routes of travel and/or other such factors. For example, clustered movement patterns may be identified that have a common origin area and common destination area. Further, the clustered movement pattern may be further focused, in some applications, to user devices traveling along similar routes of travel and/or methods of travel. Accordingly, some embodiments utilize the collective cooperation of non-affiliated information that illustrates patterns of activity to identify inventory adjustment activities. In some instances, the cooperative use of different types of information may be represented through multi-layered heat maps illustrating the different types of information. For example, a first layer may include individual data representations of a single type of analytics information and corresponding to single activity, a second layer that may provide multiple data representations for the single type of information or activity, which may lead to the recognition of lines or weighted lanes of activity, a third layer may layer multiple different types of analytics information, and a fourth layer may applying timing.

Based on clustered movement patterns, the one or more inventory adjustment activities may be implemented along one or more of the identified movement patterns, such as but not limited to adjustments at origin area, at a destination area, along the route between a common origin area and a destination area, and the like. For example, in some embodiments the inventory adjustment activity can cause a modification of inventory of a product at a location along a clustered movement pattern. Origin areas and/or destination areas may be a geographic area within which activities are taking place and/or where a group users and/or user devices start a route of movement or travel and/or end at least a portion of a route of travel. For example, a neighborhood of homes may be identified as an origin area of a group of people that may travel to a similar destination (e.g., a school, work location, mass-transit station, etc.), an apartment building may be identified as an origin area, a work area may be identified as an origin area (e.g., downtown area, business park, manufacturing facility, entertainment location, etc.) such as when people are leaving work, an entertainment location (e.g., theater, stadium, lake, beach, marina, etc.), and other such geographic areas may be considered origins. Further, the same geographic areas can also be considered destination areas depending on a direction of travel, a period of time between interruptions in a route of travel and/or other such factors. For example, a neighborhood may be considered an origin area in the morning when many people are leaving to go to work, school, etc., while the same neighborhood may be considered a destination area in the afternoon and evening when people are returning home from school, work, etc. Still further, a destination may be considered one destination in a series of destinations, while also being considered an origin to a subsequent destinations (e.g., movement from a home, to a school, to a store, to the home; where the home is an origin to the school, with the school, store and home being subsequent destinations in the series of destinations).

Furthermore, some embodiments cooperatively consider multiple different types of mobile analytics information in identifying patterns of activity, and/or in determining inventory adjustment activities or actions to implement. The determined action may be dependent, in some embodiments, one or more thresholds of the different types of mobile analytics information. For example, a first inventory adjustment activity may be instructed based on a detection of a combination of at least a first threshold corresponding to a first type of mobile analytics information, a second threshold corresponding to a second type of mobile analytics information, and a third threshold corresponding to a third type of mobile analytics information (e.g., (A>T₁ₛₜ)+(B>T_{2nd})+(C>T_{3rd}), implement a first inventory adjustment activity (AA₁); while a second inventory adjustment activity may be instructed based on a detection of a combination of at least a fourth threshold corresponding to the first type of mobile analytics information, and a fifth threshold corresponding to the third type of mobile analytics information (e.g., (A>T₄ₜₕ)+(C>T₅ₜₕ), implement a second inventory adjustment activity (AA₂). Different thresholds of different types of analytics information can be applied in determining inventory actions. Further, thresholds of one or more types of analytics information may be dependent on quantities, qualities and/or levels of one or more other types of analytics information. Similarly, thresholds may vary based on other factors, such as but not limited to time considered, duration considered, quantities of instances of mobile analytics information, types of inventory adjustments being considered, locations, other such factors, or combinations of two or more factors.

The types of inventory adjustment actions to be performed may similarly vary depending on the types of mobile analytics information available. Further, the mobile analytics information can in some instances be considered in real time, while in other instances, historic mobile analytics information may additionally or alternatively considered. For example, patterns may be identified based on multiple weeks of mobile analytics information.

In some embodiments, the inventory management control system 2220 can communicate instructions to cause the inventory adjustment activity to be implemented. The communications can include communicating orders to an inventory tracking system and/or a distribution center requesting a quantity of a product, communicating instructions to one or more workers to stock shelves, move items of one or more products, directing a vehicle to be dispatched to a location corresponding to a location, other such instructions, or combination of two or more instructions. Additionally, the adjustment activity and/or the location of adjustment activity is often based in part on expected customer reaction to the potential adjustments. Some embodiments utilize partiality vector information in identifying products and/or types of products for which inventory is to be adjusted. Further, because some or all of the aggregate mobile analytics information is anonymous the inventory management control system may not have specific customers to consider in determining inventory adjustment activity that should be implemented (e.g., for which products inventory might and/or should be adjusted).

The inventory management control system 2202, however, may be configured to identify and/or access aggregate partiality vector information. As described above, the partiality vectors can provide guidance regarding products in which customers may be interested. The aggregate mobile analytics information is often anonymous and cannot directly be associated with specific customers. The inventory management control system can use the aggregate analytics information to identify the locations of patterns of activity. Using this location information, the inventory management control system can in some embodiments be configured to identify retail customers that are associated with the pattern location corresponding to the occurrence of activities of one or more patterns of activity. These customers are not identifiably associated with the mobile analytics information. Instead, these customers are merely associated with the locations of the activities. For example, customers of a retail shopping facility that are known to the retail shopping facility (e.g., through customer databases) may be identified that live or work within a threshold distance from a threshold quantity and/or statistically relevant location of activity, live or work within an origin threshold distance of an origin area corresponding to a pattern of activity, live with a destination threshold distance from a destination of a pattern of activity, and/or are otherwise associated with an identified pattern of activity.

One or more aggregate partiality vectors corresponding to the identified retail customers can be identified based on sets of partiality vectors that are each associated with one of the identified customers. Further, in some instances, the identified partiality vectors used to define an aggregate partiality vector may have a magnitude that is at least a threshold magnitude before considering that partiality vector in determining aggregate partiality vectors. Similarly, a threshold number of customers may be needed before considering a partiality vector as an aggregate partiality vector. In some instances, a magnitude of the aggregate partiality vector may be determined based on magnitudes of customers corresponding partiality vectors (e.g., average magnitude, median magnitude, weighted based on proximity to pattern, weighted based on a statistical relevance, and/or other such factors). Using the aggregate partiality vector, the inventory management control system may identify the inventory adjustment activity, in part by identify a product consistent with the aggregate partiality vector and identify the inventory adjustment activity that affects inventory of the product at an adjustment location proximate the pattern location. Further, the inventory management control system can be configured to identify overlaps between one or more types of aggregate analytics information and one or more aggregate partiality vectors. Similarly, the inventory adjustment actions may be dependent on the degree of overlap between the aggregate mobile analytics information and the one or more aggregate partiality vectors.

Some embodiments include the resource allocation system 2212 that is configured to identify third party potential services and/or other such consumers of the aggregate mobile analytics information, identified patterns information, statically evaluations of the aggregate mobile analytics, or other such information associated with the aggregate mobile analytics information. Further, in some instances, the resource allocation system may identify third party services or other consumers that can utilize determined inventory adjustment activities identified through the inventory management control system. Such third party adjustment activities may be retail and non-retail related. For example, patterns of movement information may be provided to third party delivery services, restaurants that delivery food, trucking and/or shipping services, and the like in scheduling and routing deliveries. Similarly, city governments may utilize the information for various uses (e.g., road construction planning, traffic signal controls, and the like), tow truck services may utilize information in staging tow trucks, and other such service providers. Other service providers may adjust marketing and/or counsel clients regarding adjusting marketing; cellular phone providers may use the information in, for example, antenna distribution planning; and other third parties may use the information. In some embodiments, the resource allocation system configured to identify one or more third party sources that are predicted to benefit from the use of the aggregate mobile analytics information and/or identified patterns of such data. The resource allocation system may issue one or more notifications to a worker notifying the worker regarding the potential third party or parties. The worker may initiate negotiations with the third party in offering the information in exchange for services, financial payments and/or other arrangements. In some instances, the resource allocation systems may cause the aggregated mobile analytics information, pattern information, determined inventory adjustment activities information, and/or other such relevant information to be distributed to one or more third party sources.

FIG. 23 illustrates a simplified flow diagram of an exemplary process 2300 of managing retail inventory based on mobile analytics information, in accordance with some embodiments. In step 2302, aggregated layers of multiple different types of mobile analytics information is electronically accessed. In some embodiments, the mobile analytics information correspond to activities associated with multiple different user devices relative to a geographic area of interest. Further, some or all of the aggregated mobile analytics information often does not identify individual user devices and/or users from which the individual user devices and/or users cannot be identified solely through the aggregated mobile analytics information. In some instances, the mobile analytics information correspond to activities by tens of user devices, and often hundreds or thousands of user devices.

In step 2304, an inventory adjustment activity is identified based on at least one pattern of activity determined from the aggregated multiple different types of mobile analytics information. In some instances, the inventory adjustment activity is to be implemented as a function of the pattern of activity relative to retail services. In step 2306, instructions are communicated to cause the inventory adjustment activity to be implemented. The instructions may be communicated to an inventory tracking system 2206, communicated to a distribution center, communicated to an inventory ordering system, communicated to one or more workers (e.g., through mobile worker user devices, text message, email, etc.), communicated to service systems (e.g., delivery service system that directs the scheduling and/or routing of the delivery of products, a sales vehicle that can be stocked with preselected products based on one or more patterns of activity, and/or other such services), or other systems or services. As an example, instructions can be communicated to workers to position a selected product at one or more prominent locations within a shopping facility. As another example, instructions may be directed to communicate notifications to one or more customers offering delivery services at or near one or more determined destination locations. As one specific example, the inventory management control system may identify based on one or more real time and/or historic patterns that a set of multiple users move to a common destination area on Saturdays that is at or near a set of soccer fields, and then proceed to a set of restaurants that offer ethnic foods. Accordingly, the inventory management control system may determine an inventory activity to reposition ethic food ingredients at one or more prominent locations and/or increase stock of ethnic food ingredients, and cause instructions to be communicated to workers and/or inventory systems. In some instances, the inventory management control system may further direct instructions that cause one or more notifications to be communicated to one or more customers of a retail shopping facility in one or origin areas from which the users initiated their routes of travel.

As described above, in some embodiments the aggregate mobile analytics information may include multiple different types of analytics information. For example, aggregated mobile analytics information can include at least two of cellular mobile analytics information, wireless network access mobile analytics information, social media analytics information, timing information, access to services web sites, communications information, and other such information. Further, the aggregate mobile analytics information may include mobile analytics information collected over time, which may represent sequences of activity and movement by at least a subset of the multiple user devices.

The identification of the inventory adjustment activity may, in some implementations, comprise the identification of one or more inventory adjustment activities to cause a modification of inventory of one or more products at a retail shopping facility within a threshold distance of an origin area and/or destination area of a pattern of activity. Additionally or alternatively, some embodiment identify one or more inventory adjustment activities as a function of clustered movement patterns corresponding to multiple different mobile devices. Each of the clustered movement patterns may have a common origin area and common destination area. In some instances, the one or more identified inventory adjustment activities may include activities to cause a modification of inventory of a product at a location along one or more of the clustered movement patterns.

Some embodiments identify one or more sets of retail customers that are associated with a pattern location (e.g., origin area, destination area, along a route of travel, etc.) corresponding to the occurrence of activities of one or more patterns of activity. One or more aggregate partiality vectors can be identified that correspond to the identified retail customers based on sets of partiality vectors that are each associated with one of the identified customers. Inventory adjustment activity can be identified based on the one or more aggregate partiality vectors. In some instances, one or more products can be identified that are consistent with the aggregate partiality vector, and an inventory adjustment activity can be identified that affects inventory of the one or more products at an adjustment location proximate the pattern location. Some embodiments may additionally or alternatively identify one or more third party sources that are predicted to benefit from the use of the one or more determined inventory adjustment activities and/or aggregate mobile analytics information. One or more of the inventory adjustment activities, instructions regarding the implementation of an inventory adjustment activity, and/or aggregated mobile analytics information can be distributed (e.g., via the network 2204) to at least one of the third party sources.

In some embodiments, systems and methods are provided to manage retail product inventory. The system may include a retail product inventory distribution system, comprising: an inventory tracking system configured to maintain inventory count information of tens of thousands of products across multiple different retail shopping facilities; an inventory management control circuit coupled with the inventory tracking system and configured to couple with a source of multiple different types of mobile analytics information; wherein the inventory management control circuit is further configured to: electronically access aggregated layers of multiple different types of mobile analytics information corresponding to activities associated with multiple different electronic user devices relative to a first geographic area of interest, wherein the aggregated mobile analytics information does not identify individual user devices of the multiple user devices and from which the individual user devices cannot be identified solely through the aggregated mobile analytics information; identify, based on at least a first pattern of activity determined from the aggregated multiple different types of mobile analytics information, an inventory adjustment activity to be implemented as a function of the first pattern of activity relative to retail services; and communicate instructions to cause the inventory adjustment activity to be implemented.

Some embodiments provide methods of managing retail product inventory, comprising: electronically accessing aggregated layers of multiple different types of mobile analytics information corresponding to activities associated with multiple different electronic user devices relative to a first geographic area of interest, wherein the aggregated mobile analytics information does not identify individual user devices of the multiple user devices and from which the individual user devices cannot be identified solely through the aggregated mobile analytics information; identifying, based on at least a first pattern of activity determined from the aggregated multiple different types of mobile analytics information, an inventory adjustment activity to be implemented as a function of the first pattern of activity relative to retail services; and communicating instructions to cause the inventory adjustment activity to be implemented.

Generally speaking, pursuant to various embodiments, systems and methods are provided herein useful to preemptively present one or more purchase opportunities to a population of users at a location.

In some embodiments, systems are provided to preemptively present one or more purchase opportunities to a population of users at a location and may comprise one or more databases of information corresponding to a plurality of partiality vectors (“PVs”) each characterizing a partiality of a user or an aspect of a commercial item. One or more control circuits can be communicatively coupled to the databases and configured to access user mobile analytic data that includes information about a plurality of electronic user devices. By one approach, the user mobile analytic data can be captured at a location over a time period and may include one or more first unique identifiers for each electronic user device. In some embodiments, the control circuits can be configured to identify a threshold number of electronic user devices that are present at the location. In some embodiments, the control circuits can be configured to use one or more first unique identifiers of an identified electronic user device and one or more second unique identifiers to correlate the one or more first unique identifiers with one or more particular corresponding users, where the one or more second unique identifiers can each include identifying information for the particular corresponding user.

In some embodiments, the control circuits can be configured to ascertain one or more events associated with at least one of the identified electronic user devices and the location, where each of the events can include at least one circumstance or at least one pattern of interest. In some embodiments, the control circuits can be configured to identify one or more purchase opportunities that can each include one or more commercial items associated with at least one of the ascertained events. In some embodiments, the control circuits can be configured to assess each of the identified purchase opportunities using at least one PV included in the plurality of PVs, where this particular assess information can be used by the control circuits to identify one or more opportunities to increase a probability that at least one of the users of the threshold number of identified electronic user devices will participate in one or more of the identified purchase opportunities. By one approach, the one or more PVs can each characterize one or more partialities of a particular corresponding user.

In some embodiments, the control circuits can be configured to cause the delivery of at least one commercial item of one or more assessed purchase opportunities to the location via one or more logistics assets that can each use at least one logistics route. By one approach, each of the logistics routes can include a first area and a second area corresponding to the location and a storage location for one or more of the commercial items of an assessed purchase opportunity, respectively. In some embodiments, the location can include non-retail space. In some embodiments, each first unique identifier or second unique identifier can include at least one Media Access Control (MAC) address, a mobile device Electronic Serial Number (ESN), a mobile device International Mobile Equipment Identity (IMEI) number, and a number assigned by a wireless-communications service provider.

In some embodiments, the system can also include one or more second databases of information that can each dictate a plurality of purchase opportunities each associated with a plurality commercial items, and wherein in identifying the purchase opportunity the control circuit can identify at least one purchase opportunity of the plurality of purchase opportunities that includes a threshold number of commercial items having an association with at least one of the events. In some embodiments, the one or more control circuits can be configured to ascertain at least one first alignment value and at least second alignment value. By one approach, each first alignment value can correspond to a congruity between the partiality vectors of the user and one of the commercial items of an identified purchase opportunity, and each second alignment value can correspond to a congruity between the partiality vectors of the user and one of the second commercial item that shares a threshold number of characteristics with the first commercial item.

In some embodiments, the one or more control circuits can be configured to access at least one of the databases to ascertain one or more first scalar values that each correspond to a dot product of a partiality vector of the user and a partiality vector of the first commercial item to ascertain at least one of the first alignment value. By one approach, the one or more control circuits can be configured to access at least one of the databases to ascertain one or more second scalar values that each correspond to a dot product of the partiality vector of the user and a partiality vector of the second commercial item to ascertain at least one of the second alignment values. In some embodiments, the system can further comprising one or more second databases of information that dictates one or more logistics route for at least logistics asset and at least one scheduling event for at least one of the logistics assets. By one approach, the one or more control circuits can be configured to confirm that each scheduling event does not conflict with the delivery information of at least one of the assessed purchase opportunities.

In some embodiments, methods are provided for preemptively presenting one or more purchase opportunities to a population of users at a location. Some of the methods access user mobile analytic data that can include information corresponding to a plurality of electronic user devices. By one approach, the user mobile analytic data may be captured at a location over a time period and may include at least one first unique identifier that corresponds to a particular electronic user device. Some of the methods identify a threshold number of electronic user devices present at the location. In some embodiments, one or more of the first unique identifiers of the one or more identified electronic user devices may be correlated with one or more particular corresponding users using one or more of the first unique identifiers and one or more second unique identifiers. By one approach, each of the second unique identifiers may include identifying information for a particular corresponding user. In yet another illustrative embodiment, one or more events that are associated with at least one of the threshold number of identified electronic user devices and the location may be ascertained, where each of the one or more events may include one or more circumstances and one or more patterns of interest.

In some embodiments, one or more purchase opportunities can be identified, where each of the one or more identified purchase opportunities may dictate one or more commercial items that are associated with at least of the ascertained events. In some embodiments, one or more of the identified purchase opportunities can be assessed using partiality vectors, which can thereby facilitate identification of one or more opportunities to increase a probability that users of at least one of the identified electronic user devices can participate in one or more of the identified purchase opportunities. By one approach, each of the partiality vectors can characterize one or more partialities of a particular corresponding user or one or more aspects of one of the commercial items. In some embodiments, delivery of at least one of the assessed purchase opportunities to the location may be caused, where the delivery may be facilitated via one or more logistics assets using one or more logistics routes.

By one approach, each logistics route can include at least one first area that can each correspond to the location and at least one second area that can each correspond to a storage location for one or more commercial items dictated by at least one of the assessed purchase opportunities. In some embodiments, the location can include non-retail space. In some embodiments, each first unique identifier or second unique identifier can include at least one Media Access Control (MAC) address, a mobile device Electronic Serial Number (ESN), a mobile device International Mobile Equipment Identity (IMEI) number, and a number assigned by a wireless-communications service provider. In some embodiments, one or more of the purchase opportunities can be identified for a threshold number of commercial items that have an association with one or more of the events to identify the purchase opportunity. In some embodiments, one or more first alignment values and second alignment values may be assessed to assess an identified purchase opportunity, where each first alignment value can correspond to the congruity between partiality vectors of the user of an identified electronic user device and one of the commercial items of an identified purchase opportunity, and each second alignment value can correspond to a congruity between the partiality vectors of the user and one of the second commercial item that shares a threshold number of characteristics with the first commercial item.

In some embodiments, one or more first scalar values may be ascertained to ascertain a first alignment value, where each first scalar value can correspond to one or more dot products of the partiality vectors of the user of the identified electronic user device and one of the first commercial items. By one approach, one or more second scalar values may be ascertained to ascertain a second alignment value, where each second scalar value can correspond to one or more dot products of the partiality vectors of the user of the identified electronic user device and one of the second commercial items. In some embodiments, each of the logistics routes can be confirmed to comprise at least one scheduling event that shares a threshold amount of logistic relationships with delivery information for one or more of the assessed purchase opportunity to cause the delivery.

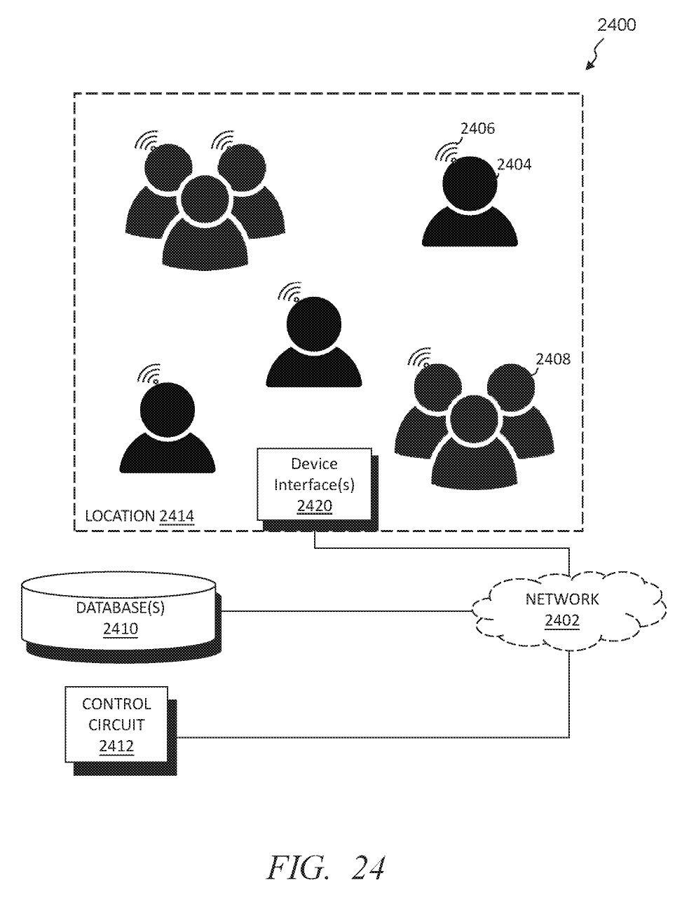

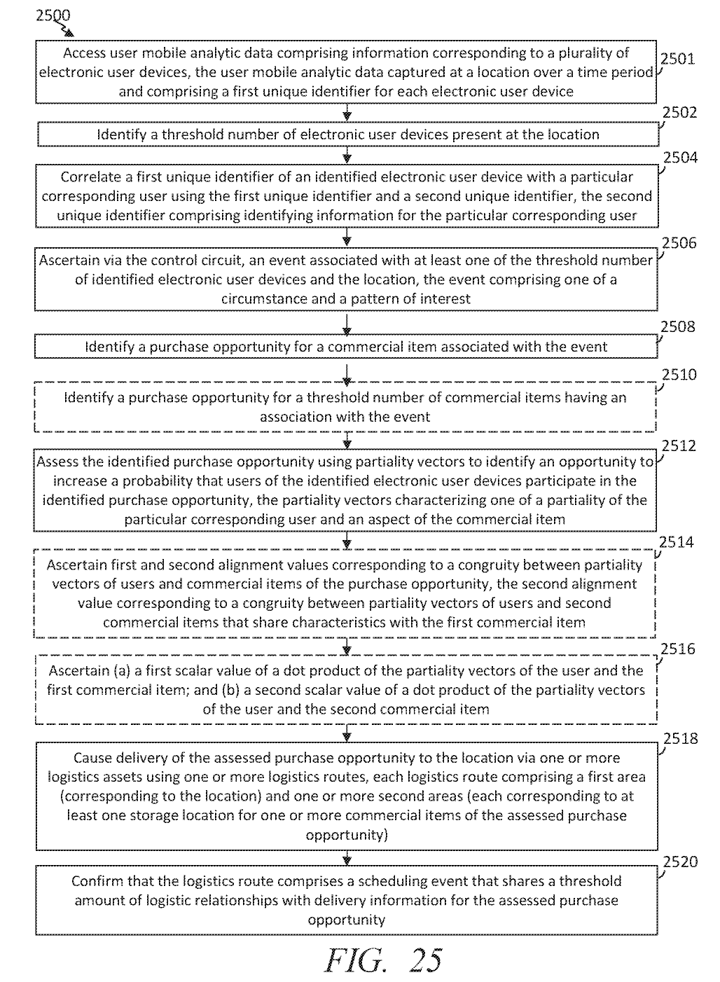

In reference to FIGS. 24-26, embodiments discussed herein correspond to preemptively presenting one or more purchase opportunities to one or more people of a population of persons (“population”) at a location and may utilize one or more concepts, steps, processes, functions, elements, and/or components discussed above in reference to one or more of FIGS. 1-21.

These teachings also contemplate an approach that permits mobile analytics information to be leveraged with information regarding partiality vectors for customers as well as vectorized characterizations for products to identify a population at a location and one or more purchase opportunities that can be presented to one or more people of the population at the location. In particular, FIG. 24 illustrates a simplified block diagram of a system 2400 to preemptively present one or more purchase opportunities to a population at a location in accordance with the teachings of some embodiments.

In this example, system 2400 can include one or more device interfaces 2420, databases 2410, and control circuits 2412 communicating over a computer and/or one or more communication networks (“networks”) 2402. Networks 2402 can be, for example, a local area network (LAN), a wide area network (WAN) such as the Internet, or a combination of the two, and includes wired, wireless, fiber optic connections, other such communication methods, or combination of two or more of such communication methods. In certain embodiments, the networks 2402 can include the networks 403 and/or 2401 or maybe included therein. In general, the network 2402 can be any combination of connections and protocols that can support communications between the device interfaces 2420, the databases 2410, and the control circuits 2412.

People (e.g., individuals 2404 and 2408) may gather at particular locations (e.g., the location 2414) to engage in one or more activities (e.g., wait for public transportation, consume food and/or beverages, participate in a political or social event, similar actions, or a combination of two or more thereof). Such persons may gather at the location for less than a threshold time period or remain at the location for at least the threshold time period. By one approach, location 2414 can include one or more non-retail spaces and/or public spaces. The presence of such persons at the location may represent an opportunity to a retail entity to enable one or more of such persons to participate in one or more purchase opportunities. Further, because the location 214 is often a location that is not typically associated with the retail entity and purchase opportunities typically associated with the retail entity, the identification of potential purchase opportunities can expand the retail entities sources of revenue, potentially increase sales, provide added benefit to potential customers, enhance potential customer awareness of the retail entity and the purchase opportunities available through the retail entity, satisfy at least a temporary need associated with the location and/or event, other such benefits, and typically a combination of two or more of such benefits. The one or more device interfaces 2420 can be configured and disposed to interact with one or more user devices 2406 proximal to the location 2414. In some embodiments, the location 2414 may be included within the region of interest 200.

In a typical application setting, this interaction includes a wireless communication of information. As used herein, an electronic user device 2406 may be considered to be positioned “proximal” to the location 2414 when the electronic user device 2406 is positioned at least partially within the location 2414 or within a threshold distance thereof (e.g., a distance limited by the wireless connection between a user device 2406 and the device interface 2420). By one approach, the device interfaces 2420 can include a network interface. So configured, the device interfaces 2420 can communicate with other network elements (such as but not limited to the databases 2410 that provides mobile analytics information per these teachings) using one or more intervening networks via the network interface.

Network interfaces, including both wireless and non-wireless platforms, are well understood in the art and require no particular elaboration here. These teachings will support using any of a wide variety of networks including, but not limited to, the Internet (i.e., the global network of interconnected computer networks that use the Internet protocol suite (TCP/IP)). The device interfaces 2420 can include one or more characteristics and/or functionalities of customer-device interfaces 405 (discussed above). By one approach, the device interfaces 2420 can include a wireless interface, such as but not limited to a Wi-Fi access point and/or a Bluetooth transceiver. For example, a plurality of the individuals 2404 may be present proximal to location 2414 and may possess an electronic user device 2406 that can emit a first unique identifier (as described above).

As an illustrative example, the electronic user devices 2406 may include smart phones, wearable computing device, mobile devices, and/or similar electronic devices having Wi-Fi and/or Bluetooth conductivity capabilities. Generally speaking, this first unique identifier does not directly identify a particular individual 2404. For example, the first unique identifier may not include the full or abridged name of the individual 2404 nor a full or abridged name of a personally-selected user avatar. In some embodiments, the individuals 2408 can represent persons present at the location 2414 that do not possess an electronic user device 2406 in their personal effects.

By one approach, the first unique identifier can comprise a Media Access Control (MAC) address for the electronic user device 2406. In some embodiments, the electronic user devices 2406 may share one or more characteristics and/or functionalities with customer devices 406. The electronic user device 2406 may be a so-called smart phone having Wi-Fi and/or Bluetooth conductivity capabilities. When an electronic user device 2406 attempts to connect to a network while within range of the one or more device interfaces 2420, the device interfaces 2420 may capture the MAC address or other first unique identifiers of the user device 2406 as it attempts to communicate at the data link layer of the network. The device interfaces 2420 can then transmit the captured MAC address to the control circuits 2412 for processing and/or to the databases 2410 for storage therein.

Referring now to FIGS. 24 and 25. In particular, a process 2500 can be at least partially implemented on one or more control circuits. For example, the one or more control circuits may be a part of a distributed system. In embodiments, the process 2500 can be at least partially implemented on one or more of the electronic user devices 2406, which can provide for a distribution of the processing tasks via the electronic user devices. In some embodiments, the one or more control circuits may be associated with one or more retail sources that can facilitate the conveyance of one or more commercial items to the location. By one approach, this process 2500 provides, at block 2501, for accessing user mobile analytic data comprising information corresponding to a plurality of electronic user devices, the user mobile analytic data captured at a location 2414 over a time period and can include one or more first unique identifiers for each electronic user device. At block 2502, the process provides for identifying a threshold number of electronic user devices present at the location 2414, each electronic user device corresponding to a respective first unique identifier. The below discussion of first unique identifiers, second unique identifiers, and partiality vectors advances the above teachings of the same. Hence, the functions, characteristics, and/or associations disclosed above for first unique identifiers, second unique identifiers, and partiality vectors also apply below. For example, one or more device interfaces 2420 can capture at location 2414 information corresponding to different electronic user devices, and includes numerous different first unique identifiers each corresponding to a different electronic user device. From the captured numerous first unique identifiers, the one or more device interfaces 2420 can identify two or more electronic user devices. In some embodiments, at least a portion of the individuals present at the location 2414 (e.g., individuals 2404) may possess an electronic user device 2406 in their personal effects. The captured information corresponding the presence of electronic user devices can vary as described above. In some embodiments, the captured information provides mapped tracking information for a plurality of electronic user devices 2406 at the location 2414 over some predetermined or threshold period of time.

At block 2504, the first unique identifiers of the identified electronic user devices may each be correlated with particular corresponding individuals using one or more first unique identifiers and second unique identifiers. The second unique identifiers may include identifying information for the particular corresponding individual. As previously discussed, first unique identifiers typically do not provide sufficient content that specifically identifies a particular individual, but they can be combined with second unique identifiers (e.g., a mobile device Electronic Serial Number (ESN), a mobile device International Mobile Equipment Identity (IMEI), a number/identifier assigned by a wireless-communications service provider and/or the party providing the first unique identifier) to identify a corresponding individual. By one approach, the databases 2410 may include information corresponding to one or more of the captured first unique identifiers, the second unique identifiers, the partiality vectors, the logistics assets, the purchase opportunities, the commercial products, the routing information, and/or other such information.

For example, some of the logistics assets can include delivery methods and/or devices, such as manned, autonomous, and/or semi-autonomous vehicles that can be used to deliver one or more commercial items as described herein (e.g., cars, vans, trucks, motorcycles, bicycles, mopeds, similar vehicular platforms, or a combination of the two). In some embodiments, logistics assets can have one or more storage areas that can each accommodate at least a portion of the commercial items dictated by a purchase opportunity. In some embodiments, logistics assets may be crowd-sourced. In some embodiments, the databases 2410 can include one or more of the memories (e.g., memory 1702, 1703, 1706).

Further, in some embodiments the databases 2410 can be at least partially implemented on one or more of the electronic user devices 2406. This provides for a distribution of the database. For example, in some instances, partiality vector information corresponding to a particular person is maintained by an electronic user device associated with that particular person. In some implementations, the processing of the database information can in part be implemented by control circuits of the electronic user devices enabling distributed processing, which can reduce processing power, speed and/or capabilities at dedicated processing systems. The electronic user device may process information to determine and/or adjust partiality vector information (e.g., magnitude and/or direction), receive determined partiality vector information and incorporate that information into the local portion of the database, and distribute some or all of the partiality vector information to one or more other devices, such as the control circuit 2412.

One or more events that are associated with at least one of the threshold number of identified electronic user devices and/or the location 2414 may be ascertained at block 2506. By one approach, events can correspond to one or more circumstances and/or patterns of interest. In some embodiments, the circumstances/patterns of interest can include one or more location types (e.g., residential or commercial), specific ranges of time (e.g., morning, afternoon, evening, night, etc.), weather conditions (e.g., sunny, clear, raining, snowing, hailing, sleeting, etc.), conditions of the body/mind (e.g., hunger, thirst, sleep, conscious, infirmity, etc.), astronomical seasons (e.g., fall, winter, spring, summer), and holidays (e.g., Christmas, Easter, Halloween, Thanksgiving, etc.), similar happenings, or a combination of two or more thereof. In some embodiments, a database of events may be accessed (e.g., from one or more news sources), and the one or more events may be ascertained using the accessed information.

Using the simple example of FIG. 2, the circumstance/pattern of interest may be ascertained in part by using the accessed mobile analytic data to identify geospatial paths taken by the identified electronic user devices 2406 within the region of interest 200. In some embodiments, the accessed user mobile analytic data may include information that dictates the geospatial paths traversed by the identified electronic user devices. Each geospatial path can include a point of origin, one or more intermediary points, and an end point (i.e., the location 2414) each of which can correspond to one or more circumstances and/or patterns of interest. In some embodiments, customer information stored on the identified electronic user devices (e.g., calendar entries, social media data, purchase data, similar stored data) may be accessed to identify one or more events associated with the location 2414.

In some embodiments, one or more news sources, event calendars, as well other publically available information sources can be accessed to identify the events associated with the location 2414. At block 2508 this process 2500 provides for identifying one or more purchase opportunities each having one or more commercial items associated with the event. In some embodiments, each circumstance/pattern of interest can be associated with one or more commercial items. In some embodiments, purchase opportunities that dictate the highest number of commercial items associated with the circumstances/patterns of interest of the event may be selected. In the present example, the one or more points of origin of the identified electronic user devices may correspond to and/or be located adjacent to the Bus Station (i.e. a commercial location accessible to the public and associated with travel that is at least one hour in duration). Such information can suggest that the individuals in possession of the identified electronic user devices may have recently traveled by bus (e.g., for a threshold duration and/or distance) and may have sustenance and/or hygiene issues associated with traveling in a confined space for at least one hour or more.

As such, one or more purchase opportunities for one or more portable food-related products (e.g., snacks, fruits, fast-food products, and/or similar portable food-) and/or hygiene-related products (e.g., tooth paste, mouthwash, moist towelettes, sanitizing gels/rubs, and/or similar hygiene-related products) can be identified. By an optional approach, at block 2510, this process 2500 can provide for identifying one or more purchase opportunities each having a threshold number of commercial items having an association with the event (e.g., share a threshold number of characteristics with the event). In some embodiments, the “threshold number of commercial items” can be set and selected as desired. By one approach the threshold is static such that the same threshold is employed regardless of the circumstances. By another approach the threshold is dynamic and can vary with such things as the relative number of identified electronic user devices and/or the amount of the mobile analytic data and/or the duration of time over which the mobile analytic data is available for each identified electronic user device.

At block 2512 the one or more identified purchase opportunities can be assessed using partiality vectors to identify an opportunity to increase the probability that one or more users of the identified electronic user devices will participate in the one or more identified purchase opportunities. As described above, the partiality vectors can each characterize a partiality of a particular corresponding user or an aspect of a particular commercial item. For example, commercial items of the identified purchase opportunities can be assessed using partiality vectors of one or more of the users of the identified electronic user devices and partiality vectors of the commercial items to ascertain the level of congruity (i.e. alignment) thereof.

This process 2500 provides, at block 2514, for ascertaining one or more first and second alignment values. In some embodiments, each first alignment value can correspond to a congruity between average partiality vectors of a group of particular users (e.g., individuals 2404) and those of the commercial items of the purchase opportunity, and each second alignment value can correspond to a congruity between the average partiality vectors of the group of particular users and those of the one or more second (i.e. additional/replacement) commercial items, which may share one or more characteristics with the first commercial item. In some embodiments, the averaged PVs may be determined as a median vector, a range of vectors (e.g., within a standard deviation), an average once one or more outliers are removed from the calculation, and/or other such considerations. Further, other factors may be taken into account, such as one or more scalers, priorities of individuals, distribution of individual partiality vectors, and/or other such factors. In some embodiments, an averaged partiality vector (PV_{avg}) can correspond to the average value of the sum of the partiality vectors of the individuals 2404 as illustrated in the below equation.

PV_{avg}=(PV₁+PV₂+ . . . +PVₙ)/n

where PV₁ corresponds to a partiality vector of user 1, PV₂ corresponds to a partiality vector of user 2, and PVₙ corresponds to a partiality vector of user n. By one approach, PV_{avg} can represent the central or typical partiality vector of the group of particular users. In certain embodiments, the highest partiality vector and/or the lowest partiality vector may be excluded from the above summation. In some embodiments, partiality vectors that exhibit a statistically significant difference from partiality vectors of the group of particular users can be removed. The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. By one approach, a second commercial item can share a threshold number of characteristics with the first commercial item

By one optional approach, the process 2500 provides for ascertaining (a) one or more first scalar values of a dot product of the averaged PVs of the group of particular users and those of the first commercial item; and (b) one or more second scalar values of a dot product of the averaged PVs of the group of particular users and the second commercial item. For example, alignment values typically can have a direct relationship with congruity. In some embodiments, the dot product of two PVs can be defined by the following equation:

IPV·UPV=|IPV|cos ⊖·|UPV|

which corresponds to a scalar value defining the extent to which the commercial item partiality vector (IPV) coincides with the direction of the averaged PV (UPV), and wherein ⊖ is the angle between IPV and UPV.

Thusly defined, the resulting scalar values are positive when the UPV and IPV pair are at least partially directed in the same direction. The scalar values are negative when the UPV and IPV pair are not at least partially directed in the same direction. Scalar values are neither positive nor negative (i.e., are equal to zero) when the UPV and IPV pair are orthogonal to each other. In some embodiments, an alignment value can reflect the dot product of a user PV and the related commercial item PV as defined above. The group of users and commercial items may each be defined using one or more UPVs and OPVs, respectively. In embodiments where consumers and commercial items are defined via one or more UPVs and OPVs, respectively, alignment values may be based on one or more dot products. Alignment values, in certain embodiments, may be based on the sum, average, difference, product, quotient, similar mathematical calculations, or a combination of two or more mathematical calculations of two or more differing dot product scalar values.

In some embodiments, commercial items can be described using one or more characteristics (e.g., freshness, sourcing, material type, production type, ecological impact, similar characteristics, or a combination of two or more thereof). For example, a group of users may be characterized by UPV₁ and UPV₂ and a commercial item characterized by IPV₁ and IPV₂. Here, UPV₁ and IPV₁ can define a related characteristic (e.g., freshness) and UPV₂ and IPV₂ can define another related characteristic (e.g., sourcing).

A first dot product (DP₁) can be derived for UPV₁ and IPV₁ and a second dot product (DP₂) can be derived for UPV₂ and IPV₂. The resultant alignment values can be defined as DP₁, DP₂, the average of DP₁ and DP₂, or the sum of DP₁ and DP₂. Although alignment values based on a single dot product can be used, where two or more partiality vectors are available, alignment values that reflect the sum or average of dot products may provide the granular details for characterizing the alignment that supports identifying opportunities to increase the probability that targeted individuals participate in the purchase opportunities. Other embodiments apply alignment rules from one or more rules databases and in part consider each alignment value relative to a corresponding alignment threshold before considering the vector. Similarly, a threshold number of alignment values having corresponding threshold values may have to be identified in determining whether there is sufficient alignment to indicate a determined probability that one or more users (i.e. individuals 2404) will participate in a purchase opportunity and/or change future purchase habits.

For example, for purchase opportunities that include a particular commercial item (e.g., a portable nourishment-related product) or type of product (e.g., products related to traveling in a confined space for a threshold distance), one or more potential replacement/additional commercial items included in the databases 2410 can be identified that have a threshold relationship to the commercial item (e.g., are similar in type to the commercial object) of the purchase opportunity (e.g., dried fruits, hydration products, sandwiches, fast food products). In some embodiments, potential replacement/additional commercial objects are identified in response to one or more alignment values (determined between product partiality vectors associated with the particular commercial and the customer's partiality vectors) that are less than one or more corresponding thresholds, a determination of a negative alignment of one or more corresponding product and averaged partiality vectors, an attempt to identify a product that may more likely be desired by one or more of the individual 2404, and/or other such conditions.

As one simple example, a purchase opportunity associated with traveling in confined spaces for a threshold distance may include a deep-fried high caloric snack product (e.g., potato chips). Through an evaluation of partiality vectors, a negative alignment value with the deep-fried high caloric snack product (e.g., the group consists of individuals that are health conscious vegetarians and may have a high magnitude partiality vector for healthy foods, and a high magnitude partiality vector for low caloric snacks) may be identified. One or more potential replacement commercial objects (e.g., a non-fried low calorie snack product such as dried fruits) can be identified that can be presented to the group in place of the original commercial object (i.e., the potato chips) as at least part of a purchase opportunity to increase the probability that one or more of the individuals 2404 will participate in the purchase opportunity.

For each potential replacement/additional commercial item identified in databases 2410 (i.e., based on one or more applied rules), PVs associated with that potential replacement/additional commercial item and averaged PVs associated with the individuals 2404 can be accessed. Based on one or more rules, both the one or more PVs associated with that particular commercial item and the one or more averaged PVs can be ascertained and one or more corresponding alignment values (as discussed above) can be generated. One or more replacement/additional commercial item, for example, having the highest generated alignment values can be selected, which may correspond to the one or more replacement/additional commercial item included in databases 2410 that are determined to have PVs that are aligned with the averaged PVs.

Similarly, one or more replacement commercial items may be identified based on a product providing the most number of alignment values that are greater than a threshold amount; may be identified based on one or more commercial items having a highest pair of alignment values; may be identified based on one or more commercial items having at least a first alignment value greater than a first threshold and a second alignment value greater than a second threshold; may be identified based on one or more commercial item having an alignment value within a standard deviation from a median value of a set of product partiality vectors; or other such alignment value relationships based on one or more alignment rules. In certain embodiments, one or more replacement commercial items share can share a threshold amount of characteristics with one or more commercial items. Some partiality vectors may further have priorities associated with them, and these priorities may indicate which corresponding alignment values are considered over other alignment values. In some embodiments, the control circuit further limits replacement commercial items to those commercial items that establish an alignment value that is greater than an alignment value between the original commercial item and the group of individuals 2404 (e.g., replacement alignment value is greater than an alignment value of the partiality vector of the original commercial item and the averaged PV).

As discussed above, purchase opportunities may be assessed to identify opportunities to include one or more replacement/additional commercial items in the purchase opportunities that may be likely to increase the probability that one or more individuals 2404 participate in the purchase opportunities. For example, one or more replacement/additional items can be identified for some or all purchase opportunities generated, purchase opportunities that have a determined individual participation rate below a threshold amount, purchase opportunities targeting a select group of individuals 2404, other similar commercial bases, or a combination of two or more thereof. For example, a purchase opportunity for a meal plan may include a red wine for the beverage selection. When presented to a group of individuals 2404 that have one or more averaged PVs that are aligned with sobriety (e.g., partiality vectors that reflect above average religious activity, consumption of certain prescription medications, being underage, or similar partialities), such partiality vectors have a poor alignment (e.g., opposite alignment or an alignment below a threshold amount) with red wine.

The purchase opportunity for the meal plan should therefore be changed/modified to include one or more beverages that each have one or more partiality vectors that have an increased alignment with sobriety relative to the group of individuals (e.g., sparkling water, iced tea, a juice, and/or other non-alcoholic beverage) compared to red wine. The aforementioned threshold amount by which replacement commercial items are identified can be set and selected as desired. By one approach, the threshold is static such that the same threshold may be employed regardless of the circumstances. By another approach, the threshold is dynamic and can vary with such things as the quantity of PVs with which alignment values are based and/or the amount of data used to generate the PVs and/or the duration of time over which the data used to generate the PVs are available. In some embodiments, replacement commercial items can be characterized as having alignment values that have a statistically significant increase over the original commercial items. For example, the aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines.

By one approach, the individual identified in some purchase opportunities may correspond to a plurality of individuals located at or associated with a particular non-retail event (e.g., sporting event, musical concert/event, political event, and/or similar non-retail events) and/or non-retail locations (e.g., residential, commercial, collegiate, and/or similar non-retail locations) such as the location 2414. It is of course possible that partiality vectors may not be available yet for each individual due to a lack of sufficient specific source information from or regarding that particular individual (e.g., one or more of the individuals 2408 at the location 2414 may not be identified because they do not possess an electronic user device 2406 at the 2414). In such cases it may nevertheless be possible to use one or more partiality vector templates that generally represent certain groups of people that fairly include a number (e.g., a threshold amount) of individuals included in the plurality of individuals. For example, if the individual's gender, age, academic status/achievements, and/or postal code are known it may be useful to utilize a template that includes one or more partiality vectors that represent some statistical average or norm of other individuals matching those (or a threshold amount) same characterizing parameters.

Multiple individuals can be identified that have a threshold relationship with one or more characterizing parameters. In some embodiments, partiality vectors for each of those individuals can be accessed and used to determine template partiality vectors. For example, a first template partiality vector may be an average of the multiple first partiality vectors associated with two or more of the multiple individuals. The template partiality vectors may be determined as a median vector, a range of vectors (e.g., within a standard deviation), an average once one or more outliers are removed from the calculation, and/or other such considerations. Further, other factors may be taken into account, such as one or more scalers, priorities of individuals, distribution of individual partiality vectors, and/or other such factors.

Of course, while it may be useful to at least begin to employ these teachings with certain plurality of persons by using one or more such templates, these teachings will also accommodate modifying (perhaps significantly and perhaps quickly) such a starting point over time as part of developing a more personal set of partiality vectors that are specific to the plurality of individuals. For example, one or more such templates can be updated, amended, re-calculated when additional information specific to the plurality of individuals is received (e.g., in databases 2410, memory 1703, memory 1706, memory 1702, and/or another memory module communicatively coupled to network 2402). A variety of templates could be developed based, for example, on professions, academic pursuits and achievements, nationalities and/or ethnicities, characterizing hobbies, and the like. By one approach, such templates may be stored in one or more of the PV databases 2410, memory 1703, memory 1706, memory 1702, other memory modules communicatively coupled to network 2402, or a combination of two or more thereof.

In some embodiments, logistics assets may utilize one or more logistics routes to deliver commercial items to the location. For example, a particular logistics route may dictate that the logistic asset travel through or near the location 2414 as well as at least one storage area of at least one commercial item of the purchase opportunity. At block 2518 the process 2500 provides for causing the delivery of the assessed purchase opportunity to the location (e.g., the location 2414) via one or more logistics assets using one or more logistics routes. The logistics routes can comprise a first area that corresponds to the location and at least one second area that corresponds to a storage location for at least one commercial item dictated by the assessed purchase opportunity. By one approach, each logistics asset may have a delivery schedule (e.g., a list of scheduling events) that dictates the one or more delivery routes, commercial items, transportation conditions, delivery dates/times, delivery addresses, similar logistics information, or a combination of two or more thereof. At block 2520 the process 2500 can provide for confirming that the logistics route comprises a scheduling event that shares a threshold amount of logistic relationships with delivery information for the assessed purchase opportunity. As used herein, a “logistic relationship” can refer to relationships based on at least one of delivery routes, commercial items, transportation conditions, delivery dates/times, delivery addresses, similar logistics information, or a combination of two or more thereof.

In some embodiments, systems are provided to preemptively present one or more purchase opportunities to a population of users at a location and may comprise one or more databases of information corresponding to a plurality of partiality vectors (“PVs”) each characterizing a partiality of a user or an aspect of a commercial item. One or more control circuits can be communicatively coupled to the databases and configured to access user mobile analytic data that includes information about a plurality of electronic user devices. By one approach, the user mobile analytic data can be captured at a location over a time period and may include one or more first unique identifiers for each electronic user device. In some embodiments, the control circuits can be configured to identify a threshold number of electronic user devices that are present at the location. In some embodiments, the control circuits can be configured to use one or more first unique identifiers of an identified electronic user device and one or more second unique identifiers to correlate the one or more first unique identifiers with one or more particular corresponding users, where the one or more second unique identifiers can each include identifying information for the particular corresponding user.

In some embodiments, the control circuits can be configured to ascertain one or more events associated with at least one of the identified electronic user devices and the location, where each of the events can include at least one circumstance or at least one pattern of interest. In some embodiments, the control circuits can be configured to identify one or more purchase opportunities that can each include one or more commercial items associated with at least one of the ascertained events. In some embodiments, the control circuits can be configured to assess each of the identified purchase opportunities using at least one PV included in the plurality of PVs, where this particular assess information can be used by the control circuits to identify one or more opportunities to increase a probability that at least one of the users of the threshold number of identified electronic user devices will participate in one or more of the identified purchase opportunities. By one approach, the one or more PVs can each characterize one or more partialities of a particular corresponding user.

In some embodiments, the control circuits can be configured to cause the delivery of at least one commercial item of one or more assessed purchase opportunities to the location via one or more logistics assets that can each use at least one logistics route. By one approach, each of the logistics routes can include a first area and a second area corresponding to the location and a storage location for one or more of the commercial items of an assessed purchase opportunity, respectively. In some embodiments, the location can include non-retail space. In some embodiments, each first unique identifier or second unique identifier can include at least one Media Access Control (MAC) address, a mobile device Electronic Serial Number (ESN), a mobile device International Mobile Equipment Identity (IMEI) number, and a number assigned by a wireless-communications service provider.

In some embodiments, the system can also include one or more second databases of information that can each dictate a plurality of purchase opportunities each associated with a plurality commercial items, and wherein in identifying the purchase opportunity the control circuit can identify at least one purchase opportunity of the plurality of purchase opportunities that includes a threshold number of commercial items having an association with at least one of the events. In some embodiments, the one or more control circuits can be configured to ascertain at least one first alignment value and at least second alignment value. By one approach, each first alignment value can correspond to a congruity between the partiality vectors of the user and one of the commercial items of an identified purchase opportunity, and each second alignment value can correspond to a congruity between the partiality vectors of the user and one of the second commercial item that shares a threshold number of characteristics with the first commercial item.

In some embodiments, the one or more control circuits can be configured to access at least one of the databases to ascertain one or more first scalar values that each correspond to a dot product of a partiality vector of the user and a partiality vector of the first commercial item to ascertain at least one of the first alignment value. By one approach, the one or more control circuits can be configured to access at least one of the databases to ascertain one or more second scalar values that each correspond to a dot product of the partiality vector of the user and a partiality vector of the second commercial item to ascertain at least one of the second alignment values. In some embodiments, the system can further comprising one or more second databases of information that dictates one or more logistics route for at least logistics asset and at least one scheduling event for at least one of the logistics assets. By one approach, the one or more control circuits can be configured to confirm that each scheduling event does not conflict with the delivery information of at least one of the assessed purchase opportunities.

In some embodiments, methods are provided for preemptively presenting one or more purchase opportunities to a population of users at a location. Some of the methods access user mobile analytic data that can include information corresponding to a plurality of electronic user devices. By one approach, the user mobile analytic data may be captured at a location over a time period and may include at least one first unique identifier that corresponds to a particular electronic user device. Some of the methods identify a threshold number of electronic user devices present at the location. In some embodiments, one or more of the first unique identifiers of the one or more identified electronic user devices may be correlated with one or more particular corresponding users using one or more of the first unique identifiers and one or more second unique identifiers. By one approach, each of the second unique identifiers may include identifying information for a particular corresponding user. In yet another illustrative embodiment, one or more events that are associated with at least one of the threshold number of identified electronic user devices and the location may be ascertained, where each of the one or more events may include one or more circumstances and one or more patterns of interest.

In some embodiments, one or more purchase opportunities can be identified, where each of the one or more identified purchase opportunities may dictate one or more commercial items that are associated with at least of the ascertained events. In some embodiments, one or more of the identified purchase opportunities can be assessed using partiality vectors, which can thereby facilitate identification of one or more opportunities to increase a probability that users of at least one of the identified electronic user devices can participate in one or more of the identified purchase opportunities. By one approach, each of the partiality vectors can characterize one or more partialities of a particular corresponding user or one or more aspects of one of the commercial items. In some embodiments, delivery of at least one of the assessed purchase opportunities to the location may be caused, where the delivery may be facilitated via one or more logistics assets using one or more logistics routes.

By one approach, each logistics route can include at least one first area that can each correspond to the location and at least one second area that can each correspond to a storage location for one or more commercial items dictated by at least one of the assessed purchase opportunities. In some embodiments, the location can include non-retail space. In some embodiments, each first unique identifier or second unique identifier can include at least one Media Access Control (MAC) address, a mobile device Electronic Serial Number (ESN), a mobile device International Mobile Equipment Identity (IMEI) number, and a number assigned by a wireless-communications service provider. In some embodiments, one or more of the purchase opportunities can be identified for a threshold number of commercial items that have an association with one or more of the events to identify the purchase opportunity. In some embodiments, one or more first alignment values and second alignment values may be assessed to assess an identified purchase opportunity, where each first alignment value can correspond to the congruity between partiality vectors of the user of an identified electronic user device and one of the commercial items of an identified purchase opportunity, and each second alignment value can correspond to a congruity between the partiality vectors of the user and one of the second commercial item that shares a threshold number of characteristics with the first commercial item.

In some embodiments, one or more first scalar values may be ascertained to ascertain a first alignment value, where each first scalar value can correspond to one or more dot products of the partiality vectors of the user of the identified electronic user device and one of the first commercial items. By one approach, one or more second scalar values may be ascertained to ascertain a second alignment value, where each second scalar value can correspond to one or more dot products of the partiality vectors of the user of the identified electronic user device and one of the second commercial items. In some embodiments, each of the logistics routes can be confirmed to comprise at least one scheduling event that shares a threshold amount of logistic relationships with delivery information for one or more of the assessed purchase opportunity to cause the delivery.

Some embodiments comprise systems to preemptively present a purchase opportunity to a population of users at a location, comprising: at least one database of information corresponding to a plurality of partiality vectors (“PVs”) each characterizing one of a partiality of a user and an aspect of a commercial item, and at least one control circuit communicatively coupled to the database. One or more control circuits can be configured to: access user mobile analytic data comprising information corresponding to a plurality of electronic user devices, the user mobile analytic data captured at a location over a time period and comprising a first unique identifier for each electronic user device; identify a threshold number of electronic user devices present at the location; use a first unique identifier of an identified electronic user device and a second unique identifier to correlate the first unique identifier with a particular corresponding user, the second unique identifier comprising identifying information for the particular corresponding user; ascertain an event associated with at least one of the identified electronic user devices and the location, the event comprising one of a circumstance and a pattern of interest; identify a purchase opportunity for a commercial item associated with the event; assess the identified purchase opportunity using a PV included in the plurality of PVs and thereby identify an opportunity to increase a probability that users of the threshold number of identified electronic user devices participate in the identified purchase opportunity, the PV characterizing a partiality of the particular corresponding user; and cause delivery of a commercial item of the assessed purchase opportunity to the location via a logistics asset using a logistics route, the logistics route comprising a first area and a second area corresponding to the location and a storage location for the commercial item of the assessed purchase opportunity, respectively.

In some embodiments, the location comprises a non-retail space. One of the first unique identifier and the second unique identifier may comprise at least one of: a Media Access Control (MAC) address; a mobile device Electronic Serial Number (ESN); a mobile device International Mobile Equipment Identity (IMEI) number; and a number assigned by a wireless-communications service provider. Some embodiments further comprise a second database of information dictating a plurality of purchase opportunities each associated with a plurality of commercial items, and wherein in identifying the purchase opportunity the control circuit identifies a purchase opportunity of the plurality of purchase opportunities comprising a threshold number of commercial items having an association with the event. The control circuit, in assessing the identified purchase opportunity, may be configured to ascertain a first alignment value and a second alignment value, the first alignment value corresponds to a congruity between partiality vectors of the user and the commercial item of the identified purchase opportunity, the second alignment value corresponds to a congruity between partiality vectors of the user and a second commercial item that shares a threshold number of characteristics with the first commercial item.

In some embodiments, in ascertaining the first alignment value, the control circuit is configured to access the database to ascertain a first scalar value corresponding to a dot product of a partiality vector of the user and a partiality vector of the first commercial item; and in ascertaining the second alignment value the control circuit is configured to access the database to ascertain a second scalar value corresponding to a dot product of the partiality vector of the user and a partiality vector of the second commercial item. Some embodiments further comprise a second database of information dictating a logistics route for a logistics asset and a scheduling event for the logistics asset, and wherein in causing delivery of the commercial items of the assessed purchase opportunity the control circuit is configured to confirm the scheduling event does not conflict with delivery information of the assessed purchase opportunity.

Some embodiments provide methods of preemptively presenting a purchase opportunity to a population of users at a location, comprising: accessing user mobile analytic data comprising information corresponding to a plurality of electronic user devices, the user mobile analytic data captured at a location over a time period and comprising a first unique identifier for each electronic user device; identifying, via a control circuit, a threshold number of electronic user devices present at the location; correlating, via the control circuit, a first unique identifier of an identified electronic user device with a particular corresponding user using the first unique identifier and a second unique identifier, the second unique identifier comprising identifying information for the particular corresponding user; ascertaining, via the control circuit, an event associated with at least one of the threshold number of identified electronic user devices and the location, the event comprising one of a circumstance and a pattern of interest; identifying, via the control circuit, a purchase opportunity for a commercial item associated with the event; assessing, via the control circuit, the identified purchase opportunity using partiality vectors to identify an opportunity to increase a probability that users of the identified electronic user devices participate in the identified purchase opportunity, the partiality vectors characterizing one of a partiality of the particular corresponding user and an aspect of the commercial item; and causing, via the control circuit, delivery of the assessed purchase opportunity to the location via a logistics asset using a logistics route, the logistics route comprising a first area and a second area corresponding to the location and a storage location for a commercial item of the assessed purchase opportunity, respectively. In some implementations, the location comprises a non-retail space.

In some embodiments one of the first unique identifier and the second unique identifier comprises at least one of: a Media Access Control (MAC) address; a mobile device Electronic Serial Number (ESN); a mobile device International Mobile Equipment Identity (IMEI) number; and a number assigned by a wireless-communications service provider. The identifying the purchase opportunity may further comprise identifying, via the control circuit, a purchase opportunity for a threshold number of commercial items having an association with the event. In some implementations, the assessing the identified purchase opportunity comprises ascertaining, via the control circuit, a first alignment value and a second alignment value, the first alignment value corresponding to a congruity between partiality vectors corresponding to a user of an identified electronic user device and the commercial item of the identified purchase opportunity, the second alignment value corresponding to a congruity between partiality vectors corresponding to one of the user of the identified electronic user device and a second commercial item that shares a threshold number of characteristics with the first commercial item. Additionally or alternatively, the ascertaining the first alignment value can comprise ascertaining, via the control circuit, a first scalar value corresponding to a dot product of the partiality vectors of the user of the identified electronic user device and the first commercial item; and the ascertaining the second alignment value comprises ascertaining, via the control circuit, a second scalar value corresponding to a dot product of the partiality vectors of the user of the identified electronic user device and the second commercial item. The causing the delivery may comprise confirming, via the control circuit, that the logistics route comprises a scheduling event that shares a threshold amount of logistic relationships with delivery information for the assessed purchase opportunity.

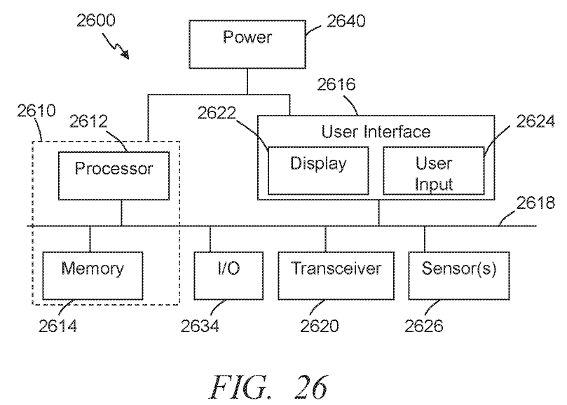

Further, the circuits, circuitry, systems, devices, processes, methods, techniques, functionality, services, servers, sources and the like described herein may be utilized, implemented and/or run on many different types of devices and/or systems. FIG. 26 illustrates an exemplary system 2600 that may be used for implementing any of the components, circuits, circuitry, systems, functionality, apparatuses, processes, or devices of the system of FIG. 4, the apparatus 1700 of FIG. 17, the retail product inventory distribution system 2200 of FIG. 22, computing device or the control circuits 401, 1701, 2102, 2412, the electronic user device 2406, one or more other control circuits and/or processing systems of the control circuits, one or more remote central control systems, and/or other above or below mentioned systems or devices, or parts of such circuits, circuitry, functionality, systems, apparatuses, processes, or devices. For example, the system 2600 may be used to implement some or all of the customer devices 406, the control circuit 401, the customer device interface 405, the control circuit 1701, the memory 1703, 1706, the inventory management control system 2202, the resource allocation system 2212, and/or other such components, circuitry, functionality and/or devices. However, the use of the system 2600 or any portion thereof is certainly not required.

By way of example, the system 2600 may comprise a control circuit or processor module 2612, memory 2614, and one or more communication links, paths, buses or the like 2618. Some embodiments may include one or more user interfaces 2616, and/or one or more internal and/or external power sources or supplies 2640. The control circuit 2612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 2612 can be part of control circuitry and/or a control system 2610, which may be implemented through one or more processors with access to one or more memory 2614 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 2600 may be used to implement one or more of the above or below, or parts of, components, circuits, systems, processes and the like. For example, the system may implement the inventory management control system 2202 with the control circuit being an inventory management control circuit, the inventory tracking system 2206 with an inventory tracking system control circuit, the resource allocation system with a resource allocation control circuit, or other components.

The user interface 2616 can allow a user to interact with the system 2600 and receive information through the system. In some instances, the user interface 2616 includes a display 2622 and/or one or more user inputs 2624, such as buttons, touch screen, track ball, keyboard, mouse, etc., which can be part of or wired or wirelessly coupled with the system 2600. Typically, the system 2600 further includes one or more communication interfaces, ports, transceivers 2620 and the like allowing the system 2600 to communicate over a communication bus, a distributed computer and/or communication network 2204 (e.g., a local area network (LAN), the Internet, wide area network (WAN), etc.), communication link 2618, other networks or communication channels with other devices and/or other such communications or combination of two or more of such communication methods. Further the transceiver 2620 can be configured for wired, wireless, optical, fiber optical cable, satellite, or other such communication configurations or combinations of two or more of such communications. Some embodiments include one or more input/output (I/O) ports 2634 that allow one or more devices to couple with the system 2600. The I/O ports can be substantially any relevant port or combinations of ports, such as but not limited to USB, Ethernet, or other such ports. The I/O interface 2634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 2626 to provide information to the system and/or sensor information that is communicated to another component, such as the central control system, a delivery vehicle, etc. The sensors can include substantially any relevant sensor, such as distance measurement sensors (e.g., optical units, sound/ultrasound units, etc.), cameras, motion sensors, inertial sensors, accelerometers, impact sensors, pressure sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 2600 comprises an example of a control and/or processor-based system with the control circuit 2612. Again, the control circuit 2612 can be implemented through one or more processors, controllers, central processing units, logic, software and the like. Further, in some implementations the control circuit 2612 may provide multiprocessor functionality.

The memory 2614, which can be accessed by the control circuit 2612, typically includes one or more processor readable and/or computer readable media accessed by at least the control circuit 2612, and can include volatile and/or nonvolatile media, such as RAM, ROM, EEPROM, flash memory and/or other memory technology. Further, the memory 2614 is shown as internal to the control system 2610; however, the memory 2614 can be internal, external or a combination of internal and external memory. Similarly, some or all of the memory 2614 can be internal, external or a combination of internal and external memory of the control circuit 2612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 2204. The memory 2614 can store code, software, executables, scripts, data, content, lists, programming, programs, log or history data, user information, customer information, product information, and the like. While FIG. 26 illustrates the various components being coupled together via a bus, it is understood that the various components may actually be coupled to the control circuit and/or one or more other components directly.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801, filed Apr. 18, 2017; 62/510,322, filed May 24, 2017; 62/510,317, filed May 24, 2017; Ser. No. 15/606,602, filed May 26, 2017; 62/513,490, filed Jun. 1, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; 62/527,445 filed Jun. 30, 2017; Ser. No. 15/655,339 filed Jul. 20, 2017; Ser. No. 15/669,546 filed Aug. 4, 2017; and 62/542,664 filed Aug. 8, 2017; 62/542,896 filed Aug. 9, 2017; Ser. No. 15/678,608 filed Aug. 16, 2017; 62/548,503 filed Aug. 22, 2017; 62/549,484 filed Aug. 24, 2017; Ser. No. 15/685,981 filed Aug. 24, 2017; 62/558,420 filed Sep. 14, 2017; Ser. No. 15/704,878 filed Sep. 14, 2017; and 62/559,128 filed Sep. 15, 2017.

What is claimed is:

1. A retail product inventory distribution system, comprising:
an inventory tracking system receiving signals comprising inventory information and configured to maintain inventory count information of tens of thousands of products across multiple different retail shopping facilities;
an inventory management control circuit coupled with the inventory tracking system and configured to couple with a source of multiple different types of mobile analytics information;
wherein the inventory management control circuit is further configured to: electronically access aggregated layers of multiple different types of mobile analytics information corresponding to activities associated with multiple different electronic user devices relative to a first geographic area of interest, wherein the aggregated mobile analytics information does not identify individual user devices of the multiple user devices and from which the individual user devices cannot be identified solely through the aggregated mobile analytics information; identify, based on at least a first pattern of activity determined from the aggregated multiple different types of mobile analytics information, an inventory adjustment activity to be implemented as a function of the first pattern of activity relative to retail services; and communicate instructions to cause the inventory adjustment activity to be implemented.

2. The system of claim 1, wherein the aggregate mobile analytics information comprises at least two of cellular mobile analytics information, wireless network access mobile analytics information, and social media analytics information.

3. The system of claim 2, wherein the aggregate mobile analytics information comprises mobile analytics information collected over time and represents sequences of activity and movement by at least a subset of the multiple user devices.

4. The system of claim 1, wherein the inventory management control circuit is configured to identify the inventory adjustment activity to cause a modification of inventory of one or more products at a retail shopping facility within a threshold distance of an origin area of the first pattern of activity.

5. The system of claim 1, wherein the inventory management control circuit is configured to identify the inventory adjustment activity as a function of clustered movement patterns corresponding to multiple different mobile devices, wherein each of the clustered movement patterns, including the first pattern of activity, have a common origin area and common destination area.

6. The system of claim 5, wherein the inventory management control circuit is configured to identify the inventory adjustment activity to cause a modification of inventory of a product at a location along a first clustered movement pattern of the clustered movement patterns.

7. The system of claim 1, wherein the inventory management control circuit is configured to identify retail customers that are associated with a pattern location corresponding to the occurrence of activities of the first pattern of activity, and identify an aggregate partiality vector corresponding to the identified retail customers based on sets of partiality vectors that are each associated with one of the identified customers; wherein the inventory management control circuit in identifying the inventory adjustment activity is configured identify a product consistent with the aggregate partiality vector and identify the inventory adjustment activity that affects inventory of the product at an adjustment location proximate the pattern location.

8. The system of claim 1, further comprising:
a resource allocation system configured to identify third party services that are predicted to benefit from the use of the aggregate mobile analytics information, and cause the aggregated mobile analytics information to be distributed to at least one of the third party services.

9. A method of distributing retail product inventory based in part on analytics information, comprising:
electronically accessing aggregated layers of multiple different types of mobile analytics information corresponding to activities associated with multiple different electronic user devices relative to a first geographic area of interest, wherein the aggregated mobile analytics information does not identify individual user devices of the multiple user devices and from which the individual user devices cannot be identified solely through the aggregated mobile analytics information;
identifying, based on at least a first pattern of activity determined from the aggregated multiple different types of mobile analytics information, an inventory adjustment activity to be implemented as a function of the first pattern of activity relative to retail services; and
communicating instructions to cause the inventory adjustment activity to be implemented.

10. The method of claim 9, wherein the aggregate mobile analytics information comprises at least two of cellular mobile analytics information, wireless network access mobile analytics information, and social media analytics information.

11. The method of claim 10, wherein the aggregate mobile analytics information comprises mobile analytics information collected over time and represents sequences of activity and movement by at least a subset of the multiple user devices.

12. The method of claim 9, wherein the identifying the inventory adjustment activity comprises identifying the inventory adjustment activity to cause a modification of inventory of one or more products at a retail shopping facility within a threshold distance of an origin area of the first pattern of activity.

13. The method of claim 9, wherein the identifying the inventory adjustment activity comprises identifying the inventory adjustment activity as a function of clustered movement patterns corresponding to multiple different mobile devices, wherein each of the clustered movement patterns, including the first pattern of activity, have a common origin area and common destination area.

14. The method of claim 13, wherein the identifying the inventory adjustment activity comprises identifying the inventory adjustment activity to cause a modification of inventory of a product at a location along a first clustered movement pattern of the clustered movement patterns.

15. The method of claim 9, further comprising:
identifying retail customers that are associated with a pattern location corresponding to the occurrence of activities of the first pattern of activity; and
identifying an aggregate partiality vector corresponding to the identified retail customers based on sets of partiality vectors that are each associated with one of the identified customers;
wherein the identifying the inventory adjustment activity comprises identifying a product consistent with the aggregate partiality vector and identifying the inventory adjustment activity that affects inventory of the product at an adjustment location proximate the pattern location.

16. The method of claim 9, further comprising:
identifying third party services that are predicted to benefit from the use of the aggregate mobile analytics information, and distributing the aggregated mobile analytics information to at least one of the third party services.
